(19) United States
(12) Patent Application Publication
(10) Pub. No.: US 2026/0186440 A1
(43) Pub. Date: Jul. 2, 2026

(54) SHEET PROCESSING APPARATUS AND IMAGE FORMING SYSTEM

(71) Applicant: CANON FINETECH NISCA INC., Saitama (JP)

(72) Inventors: Shinnosuke Enomoto, Yamanashi (JP); Shoubu Kato, Yamanashi (JP); Hiroki Komada, Yamanashi (JP); Akito Yoda, Yamanashi (JP); Taiki Akiyama, Kanagawa (JP)

(21) Appl. No.: 19/543,235

(22) Filed: Feb. 18, 2026

Related U.S. Application Data
(63) Continuation of application No. PCT/JP2024/030102, filed on Aug. 23, 2024.

(30) Foreign Application Priority Data
Aug. 30, 2023 (JP) 2023-140506

(51) Int. Cl. G03G 15/00

(52) U.S. Cl. CPC G03G 15/6544; G03G 2215/00877

(57) ABSTRACT

A square back processing unit performs a square back process to press, by a pressing roller, the spine of a sheet bundle clamped by a pair of clamping units such that the spine of the sheet bundle protrudes downstream with respect to the pair of clamping units. A controller is capable of executing a mode in which, in a state in which the nipping by the pair of clamping units on the sheet bundle subjected to the square back process by the square back processing unit is released, the sheet bundle subjected to the square back process is conveyed downstream in a conveyance direction by a conveyance unit, and the square back process is performed again by the square back processing unit to the sheet bundle.

### CROSS-REFERENCE TO RELATED APPLICATIONS

This application is a Continuation of International Patent Application No. PCT/JP2024/030102, filed Aug. 23, 2024, which claims the benefit of Japanese Patent Application No. 2023-140506, filed Aug. 30, 2023, both of which are hereby incorporated by reference herein in their entirety.

### BACKGROUND

### Field of the Technology

The present disclosure relates to a sheet processing apparatus that performs a square back process on sheets, and an image forming system including the sheet processing apparatus.

### Description of the Related Art

As a sheet processing apparatus, a configuration in which, in a state in which a half-folded sheet bundle is clamped by a pair of clamping units, a process (hereinafter referred to as a square back process) of forming corners on the spine of the sheet bundle by a roller pressing the spine of the sheet bundle protruding more than the clamping units while the roller is moving is proposed (Japanese Patent Laid-Open No. 2001-260564).

### SUMMARY

In the case of the configuration described in Patent Literature 1, the distance between a stopping plate and the clamping units (amount of protrusion of the spine of the sheet bundle from the clamping units) is adjusted in accordance with the bulkiness (thickness) of the sheet bundle based on the number, material, and the like of sheets included in the sheet bundle. In this case, it is considered that the square back process on the spine of the sheet bundle can be performed nicely by increasing the protrusion amount of the spine of the sheet bundle from the clamping unit as the number of sheets included in the sheet bundle increases. To be noted, in the configuration described above, the intensity of the square back process (finish of the product of the square back process) changes by adjusting the protrusion amount of the spine of the sheet bundle from the clamping units, and therefore adjusting the protrusion amount of the spine of the sheet bundle on the basis of a user operation can be also considered.

In this case, there is a possibility that depending on the adjustment based on the information of the sheet bundle or the adjustment based on the user operation, the spine of the sheet bundle is damaged when the pressing roller starts moving and pressing the spine of the sheet bundle and a product desired by the user cannot be obtained as the protrusion amount of the spine of the sheet bundle from the clamping unit increases.

The present disclosure is to provide a configuration capable of suppressing the damage to the spine of the sheet bundle when performing the square back process on the sheet bundle.

### Solution to Problem

According to a first aspect of the present disclosure, a sheet processing apparatus includes a conveyance unit configured to convey a sheet bundle subjected to a saddle binding process and a half-folding process such that a spine of the sheet bundle is positioned downstream of a fore edge thereof in a conveyance direction, a square back processing unit including a pair of clamping units configured to clamp and release a sheet bundle conveyed by the conveyance unit and a pressing roller, the square back processing unit being configured to perform a square back process in which the pair of clamping units clamp the sheet bundle such that the spine of the sheet bundle protrudes downstream from the pair of clamping units in the conveyance direction and the pressing roller presses the spine of the sheet bundle toward the pair of clamping units while moving along the spine of the sheet bundle clamped by the pair of clamping units, and, a controller capable of executing a mode in which, the square back processing unit perform the square back process to the sheet bundle conveyed by the conveyance unit, after the pair of clamping units release the clamping of the sheet bundle subjected to the square back process, the conveyance unit conveys the sheet bundle downstream in the conveyance direction, and the square back processing unit performs the square back process to the sheet bundle conveyed downstream by the conveyance unit again.

According to a second aspect of the present disclosure, an image forming system includes an image forming unit configured to form an image on a sheet, a saddle binding processing unit configured to perform a saddle binding process on a sheet bundle including the sheet on which the image has been formed by the image forming unit, a half-folding processing unit configured to perform a half-folding process on the sheet bundle subjected to the saddle binding process by the saddle binding processing unit, a conveyance unit configured to convey the sheet bundle subjected to the saddle binding process and the half-folding process such that a spine of the sheet bundle is positioned downstream of a fore edge thereof in a conveyance direction, a square back processing unit including a pair of clamping units configured to clamp and release a sheet bundle conveyed by the conveyance unit and a pressing roller, the square back processing unit being configured to perform a square back process in which the pair of clamping units clamp the sheet bundle such that the spine of the sheet bundle protrudes downstream from the pair of clamping units in the conveyance direction and the pressing roller presses the spine of the sheet bundle toward the pair of clamping units while moving along the spine of the sheet bundle clamped by the pair of clamping units, and, a controller capable of executing a mode in which, the square back processing unit perform the square back process to the sheet bundle conveyed by the conveyance unit, after the pair of clamping units release the clamping of the sheet bundle subjected to the square back process, the conveyance unit conveys the sheet bundle downstream in the conveyance direction, and the square back processing unit performs the square back process to the sheet bundle conveyed downstream by the conveyance unit again.

Features of the present disclosure will become apparent from the following description of embodiments with reference to the attached drawings.

### BRIEF DESCRIPTION OF THE DRAWINGS

FIG. 1 is a schematic configurational section view of an image forming system according to an embodiment.

FIG. 2 is a schematic configurational section view of a sheet processing apparatus according to the embodiment.

FIG. 3 is a control block diagram of the image forming system according to the embodiment.

FIG. 4 is an enlarged section view of a saddle portion according to the embodiment.

FIG. 5 is a front view of a square back processing unit according to the embodiment.

FIG. 6A is a perspective view of a pressing roller unit according to the embodiment.

FIG. 6B is a section view of the pressing roller unit according to the embodiment.

FIG. 7A is a perspective view of the square back processing unit according to the embodiment as viewed from the front side.

FIG. 7B is a perspective view of the square back processing unit according to the embodiment as viewed from the rear side.

FIG. 8 is a perspective view of the pressing roller unit and part of a driving portion according to the embodiment.

FIG. 9 is a perspective view of part near the square back processing unit according to the embodiment.

FIG. 10 is a section view of the pressing roller unit and clamping units according to the embodiment.

FIG. 11A is a schematic diagram illustrating a state in which the conveyance of a sheet bundle is stopped in the operation of a square back process in the embodiment.

FIG. 11B is a schematic diagram illustrating a state in which the sheet bundle is clamped in the operation of the square back process in the embodiment.

FIG. 11C is a schematic diagram illustrating a state in which the square back process is performed on the sheet bundle in the operation of the square back process in the embodiment.

FIG. 11D is a schematic diagram illustrating a state in which the clamping of the sheet bundle is released in the operation of the square back process in the embodiment.

FIG. 12A is a schematic diagram illustrating a state in which the conveyance of the sheet bundle is stopped at the clamping units in the operation of the second square back process in the embodiment.

FIG. 12B is a schematic diagram illustrating a state in which the sheet bundle is clamped in the operation of the second square back process in the embodiment.

FIG. 12C is a schematic diagram illustrating a state in which the second square back process is performed on the sheet bundle in the operation of the second square back process in the embodiment.

FIG. 12D is a schematic diagram illustrating a state in which the clamping of the sheet bundle is released in the operation of the second square back process in the embodiment.

FIG. 13 is a diagram illustrating a mode selection screen according to the embodiment.

FIG. 14 is a diagram illustrating a warning screen according to the embodiment.

FIG. 15 is a diagram illustrating a cancelling screen according to the embodiment.

FIG. 16 is a flowchart illustrating an example of control of the square back process according to the embodiment.

### DESCRIPTION OF THE EMBODIMENTS

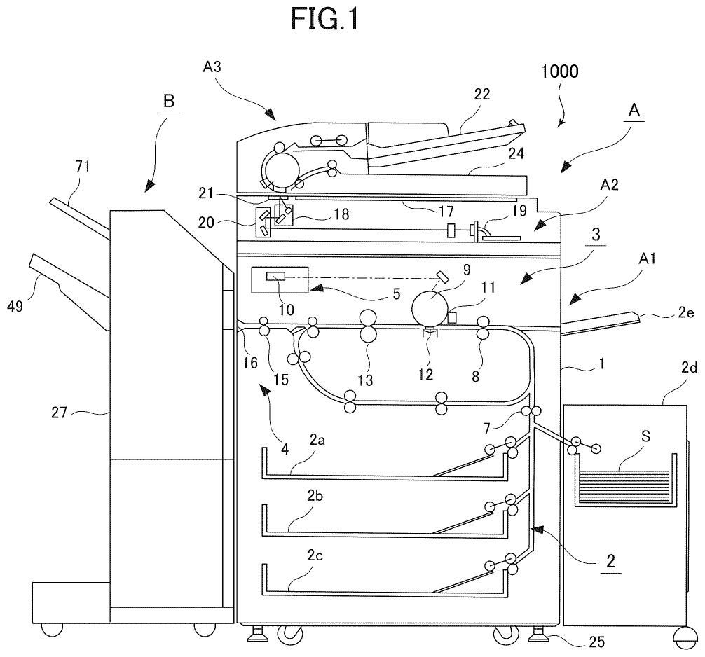

An embodiment will be described with reference to FIGS. 1 to 16B. First, a schematic configuration of an image forming system of the present embodiment will be described with reference to FIG. 1.

### Image Forming System

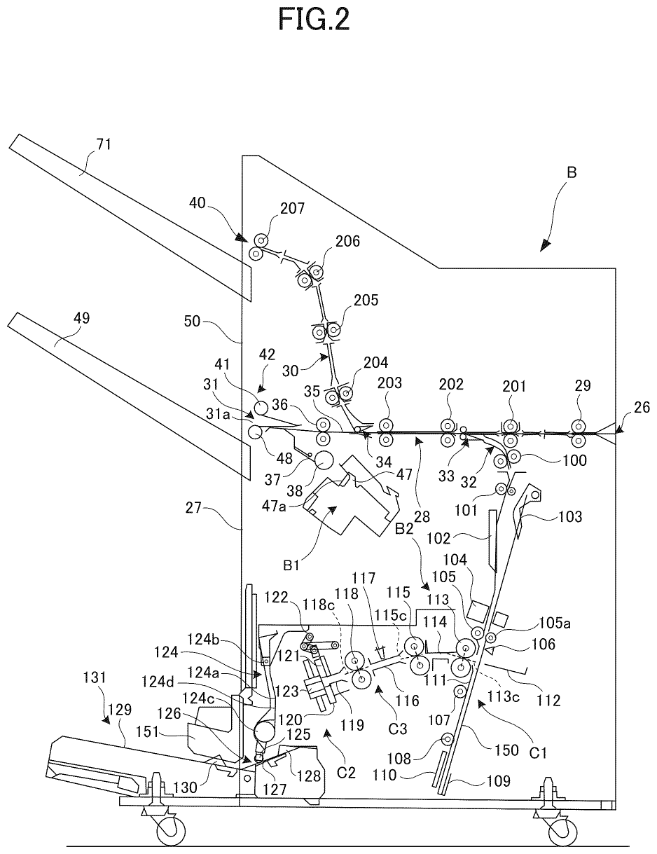

In the present embodiment, a copier is used as the image forming apparatus. A sheet processing apparatus is connected to a sheet discharge port of this copier, and the sheet processing apparatus includes a saddle portion that performs a saddle binding process and a half-folding process. The image forming system 1000 includes an image forming apparatus A and a sheet processing apparatus B. A sheet S on which an image has been formed by the image forming apparatus A is received by the sheet processing apparatus B provided on the downstream side, is subjected to the saddle binding process, the half-folding process, the square back process, and the like if necessary, and is discharged to a discharge portion provided on the downstream side. Examples of the image forming apparatus A include apparatuses of various structures such as copiers, printer, printing machines, facsimile machines, and multifunctional apparatuses having a plurality of functions of these. The image forming apparatus A and the sheet processing apparatus B will be described in detail below. To be noted, in the description below, regarding the image forming apparatus A and the sheet processing apparatus B, the side on which an operator such as a user operates the apparatus (for example, the side on which an operation panel, an operation button, and the like are provided) will be referred to as the front side (front side of the paper surface in FIGS. 1, 2, and the like), and the side opposite to the front side will be referred to as the rear side (back side of the paper surface in FIGS. 1, 2, and the like).

### Image Forming Apparatus

As illustrated in FIG. 1, the image forming apparatus A includes an image forming unit A1, an image reading unit A2, and a document feeding unit A3. The image forming unit A1 includes, in a housing 1, a feeding portion 2, an image forming portion 3, a discharge portion 4, and a data processing portion 5.

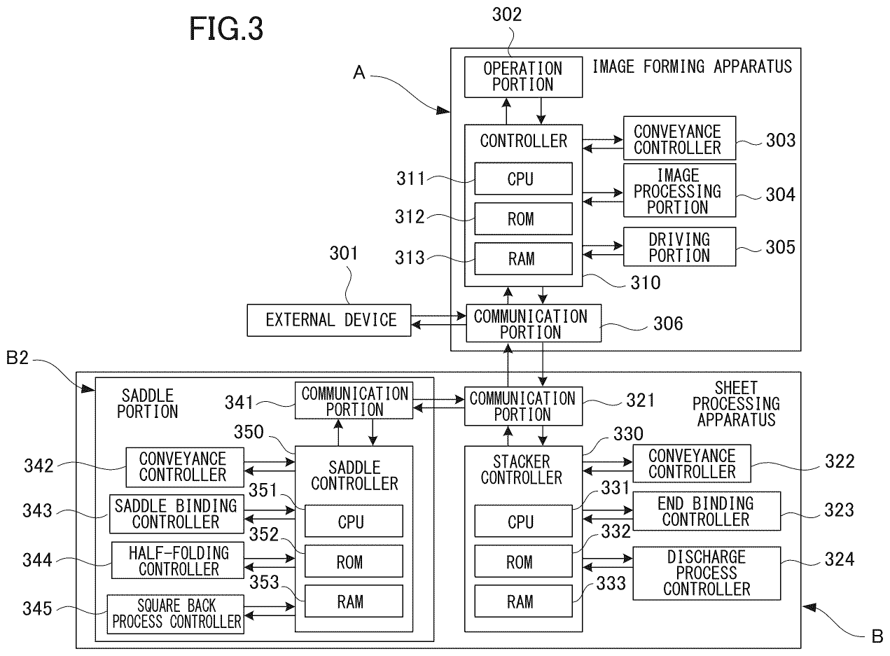

The feeding portion 2 includes a plurality of cassettes 2a, 2b, and 2c, and in the cassettes 2a, 2b, and 2c are capable of accommodating, in a plurality of tiers, sheets S of different regular sizes that are selected in advance. The sheet S is, for example, a paper sheet, a plastic sheet, or the like. The cassettes 2a, 2b, and 2c each include a separation mechanism that separates the sheets S stored therein from each other, and a feeding mechanism that delivers out the sheet S. Regarding the sheet S accommodated in the feeding portion 2 configured in this manner, the sheet S of a size designated by a controller 310 (FIG. 3) of the image forming apparatus A is delivered out. The sheet S fed from one of the plurality of cassettes 2a, 2b, and 2c is conveyed further downstream by a conveyance roller 7. The leading end of the sheet S conveyed by the conveyance roller 7 is aligned by a registration roller pair 8, and thus the skew thereof is corrected. Then, the sheet S whose leading end is aligned by the registration roller pair 8 is fed to the image forming portion 3 provided on the downstream side at a predetermined timing.

A large-capacity cassette 2d and a manual feed tray 2e are coupled to the image forming apparatus A. The large-capacity cassette 2d is constituted by an optional unit storing sheets of a size that is consumed by a large amount. The manual feed tray 2e is configured to be capable of feeding special sheets such as cardboard sheets, coated sheets, and film sheets that are difficult to separate for conveyance.

It suffices as long as the image forming portion 3 is configured to form an image on the sheet S fed from the feeding portion 2, and various image forming mechanisms can be employed. In the illustrated embodiment, an electrostatic image forming mechanism is illustrated as the image forming portion 3. However, the image forming portion 3 is not limited to the electrostatic image forming mechanism that is illustrated, and an ink jet image forming mechanism, an offset image forming mechanism, and the like can be also employed.

The image forming portion 3 illustrated in FIG. 1 is provided with a photosensitive member 9 formed in a drum shape or a belt shape, an exposing unit 10 that exposes the photosensitive member 9, a developing unit 11 that develops an electrostatic latent image on the photosensitive member 9 by using toner, and a cleaner (not illustrated) that cleans an unillustrated charging unit that charges the photosensitive member 9, the photosensitive member 9, and the like. In FIG. 1, a monochromatic printing mechanism is illustrated as an example. An electrostatic latent image is formed on the photosensitive member 9 by exposure by the exposing unit 10 and is developed by the developing unit 11, and thus a toner image is formed on the photosensitive member 9. The toner image formed on the photosensitive member 9 is, by a transfer unit 12, transferred onto the sheet S conveyed from the registration roller pair 8. The sheet S onto which a toner image has been transferred is fixed by the fixing unit 13. In addition, the image forming apparatus A is provided with a reverse conveyance path, the sheet S to which the toner image has been fixed by a fixing unit 13 is inverted such that the front surface and the back surface thereof are switched and is then conveyed to the registration roller pair 8 again, and image formation is performed on the back surface of the sheet S. A discharge roller 15 is provided downstream of the fixing unit 13 and downstream of a branching point to the reverse conveyance path, and conveys the sheet S from a discharge port 16 of the image forming apparatus A to the sheet processing apparatus B that will be described later.

An image reading unit A2 that optically reads a document image is provided above the image forming unit A1 configured in this manner, and a document feeding unit A3 is further provided above the image reading unit A2.

The image reading unit A2 includes a first platen glass 17, a second platen glass 21, a reading carriage 18 including a light source, a photoelectric conversion element 19, and a reduction optical system 20 constituted by combining mirrors and lenses. Further, the reading carriage 18 is moved in a scanning manner along the first platen glass 17 to irradiate an image of a document placed on the first platen glass 17 with light from the light source, and reflection light from the image of the document is guided to the photoelectric conversion element 19 through the reduction optical system 20 to read the image. The photoelectric conversion element 19 converts image data into an electric signal and transfers the electric signal to the image forming portion 3, and thus the image read by the image reading unit A2 can be formed on a sheet by the image forming unit A1.

The document feeding unit A3 includes a feeding tray 22 and a discharge tray 24, conveys documents placed on the feeding tray 22 one by one through a space on the second platen glass 21, and discharges the document onto the discharge tray 24. To be noted, when reading the document fed by the document feeding unit A3 and passing through the space on the second platen glass 21, the reading carriage 18 is stopped at a position below the second platen glass 21 in advance, and image data is read from an image passing through the space on the second platen glass 21.

### Overall Configuration of Sheet Processing Apparatus

Next, an overall configuration of the sheet processing apparatus B that performs a process such as a stapling process, a folding process, and the like on sheets conveyed from the image forming apparatus A will be described next with reference to FIG. 2. FIG. 2 illustrates a detailed configuration of the sheet processing apparatus B. The sheet processing apparatus B is capable of stacking sheets on a first tray (first stacking tray) 49, a saddle discharge unit 131, and a second tray (second stacking tray) 71 that will be described later after processing the sheets received through an inlet portion 26 serving as an inlet of a conveyance path 28 continuous from the discharge port 16. In the present embodiment, a path refers to the entirety of a path in which a sheet is conveyed by a conveyance guide, a conveyance roller, and the like.

In the illustrated apparatus, the sheet conveyed to the conveyance path 28 serving as a conveyance path and a first conveyance path is discharged onto a first tray 49 after being processed by a processing portion B1 that will be described later, or the sheet conveyed in the conveyance path 28 is discharged onto the second tray 71, or is discharged to a saddle discharge unit 131 after being processed by a saddle portion B2 that will be described later. Each apparatus includes a controller, a communication portion, and the like as indicated by blocks representing the overall control configuration of the apparatus illustrated in FIG. 3, and thus the apparatus is controlled.

The processing portion B1 serving as an end binding processing portion is disposed below a path outlet (passing portion 35) of the conveyance path 28, and is capable of accumulating a plurality of sheets sequentially passed on thereto from the conveyance path 28 through the passing portion 35 for each copy to form a sheet bundle, and executing a binding process serving as an example of a predetermined process on an end portion of the sheet bundle. The sheet bundle subjected to the binding process is stacked on the first tray 49 serving as a stacking portion. The trailing end (upstream end) of the sheet or sheet bundle stacked on the first tray 49 abuts a stacking wall 50 provided on the upstream side in the sheet discharge direction of the first tray 49, and is thus stacked along the stacking wall 50.

The first tray 49 is capable of moving up and down with respect to a processing tray 37 that will be described later, and supports thereon a sheet bundle subjected to the binding process by a binding processing mechanism 47 that will be described later. In the present embodiment, the first tray 49 and the second tray 71 are capable of moving up and down by an unillustrated lifting/lowering mechanism. That is, in the present embodiment, when delivering out the sheet onto the first tray 49 or the second tray 71 serving as a stacking tray, the first tray 49 or the second tray 71 is moved up or down to maintain the position of the uppermost sheet on the stacking surface of the tray constant with respect to the discharge roller pair 42 and a second discharge roller 207 such that the alignment of the stacked sheets is not degraded.

The saddle portion B2 is disposed below the passing portion of the saddle path 32 serving as a second conveyance path branching downward in the vertical direction from the conveyance path 28, accumulates a plurality of sheets sequentially passed on thereto from the conveyance path 28 through the saddle path 32 and the passing portion for each copy to form a sheet bundle, performs a folding process after executing a saddle binding process or without performing the saddle binding process, and discharges the sheet bundle to the saddle discharge unit 131. Detailed description of each configuration will be given below.

### Housing

As illustrated in FIG. 2, the sheet processing apparatus B includes a housing 27, the conveyance path 28, the processing portion B1, the saddle portion B2, the first tray 49, the saddle discharge unit 131, the second tray 71, and the like. The conveyance path 28, the processing portion B1, and the saddle portion B2 are disposed inside the housing 27. In addition, the conveyance path 28 includes the inlet portion 26 and the passing portion 35 for the sheet. The processing portion B1 and the saddle portion B2 process the sheet passed on thereto from the passing portion 35 of the conveyance path 28. The first tray 49, the saddle discharge unit 131, and the second tray 71 support thereon a sheet conveyed from each processing portion. The illustrated housing 27 is connected to a housing 1 of the image forming apparatus A positioned upstream thereof in the sheet conveyance direction in the conveyance path 28. Further, the housing 27 and the housing 1 are disposed such that the height of the discharge port 16 of the image forming apparatus A from the installation surface and the height of the inlet portion 26 of the sheet processing apparatus B from the installation surface are approximately equal, and the discharge port 16 and the inlet portion 26 are connected.

### Sheet Introduction Path

The conveyance path 28 serving as a sheet introduction path is configured as an approximately linear path traversing the housing 27 in an approximately horizontal direction, and includes the inlet portion 26 continuous with the discharge port (body discharge port) 16 of the image forming apparatus A and the passing portion 35 positioned on the opposite side across the apparatus with respect to the inlet portion 26. In the conveyance path 28, an inlet roller 29, a first conveyance roller 201, a second conveyance roller 202, and a third conveyance roller 203 serving as conveyance rollers capable of conveying the sheet in a first direction from the inlet portion 26 toward a first discharge path 31 and capable of conveying the sheet in a second direction from the first discharge path 31 toward the inlet portion 26. That is, the inlet roller 29, the first conveyance roller 201, the second conveyance roller 202, and the third conveyance roller 203 are capable of conveying the sheet in the first direction and the second direction opposite to the first direction in the conveyance path, and are arranged in this order from the inlet portion 26 side in the first direction.

The first discharge path 31 is connected to the passing portion 35 of the conveyance path 28, and the first conveyance roller 36 is disposed at a connecting portion of these. The sheet passed on from the conveyance path 28 to the first discharge path 31 and discharged from the first discharge path 31 is stacked on the first tray 49 or guided to the processing portion B1. To be noted, each conveyance roller described above may be a different member capable of conveying a sheet such as a conveyance belt.

### Layout of Sheet Introduction Path

The saddle path 32 and the upper conveyance path 30 that are branch paths are connected to the conveyance path 28 as illustrated in FIG. 2. The saddle path 32 and the upper conveyance path 30 are arranged in this order from the inlet portion 26 toward the first discharge path 31 in the first direction. In addition, the saddle path 32 branches downward from the conveyance path 28 in the vertical direction, and the upper conveyance path 30 branches upward from the conveyance path 28 in the vertical direction. A saddle path switching member 33 and an upper conveyance path switching member 34 serving as switching members that switch the conveyance direction of the conveyed sheet are respectively disposed at the respective branching portions between the conveyance path 28 and the saddle path 32 and between the conveyance path 28 and the upper conveyance path 30.

### Branching Portion of Path

The upper conveyance path switching member 34 is constituted by a switching guide capable of moving to change the conveyance path of the sheet introduced from the inlet portion 26 to convey the sheet to the first discharge path 31 or the upper conveyance path 30, and is moved by a driving portion (not illustrated) such as an electromagnetic solenoid or a mini motor.

### Upper Conveyance Path

The upper conveyance path 30 (print-out discharge path) in which a sheet other than a sheet to be discharged to the first discharge path 31 is conveyed branches from the conveyance path 28, and the upper conveyance path switching member 34 for guiding the sheet to the upper conveyance path 30 is provided at the path branching portion thereof. In addition, in the upper conveyance path 30, a fourth conveyance roller 204, a fifth conveyance roller 205, a sixth conveyance roller 206, and a second discharge roller 207 are provided in the upper conveyance path 30 as conveyance rollers that guide the sheet to the second tray 71. As a result of this, the sheet guided to the upper conveyance path 30 is discharged onto the second tray 71 (overflow tray) from an upper conveyance path discharge port 40.

The processing portion B1 is constituted by a processing tray 37 serving as a placement portion that places thereon a sheet conveyed through the first discharge path 31 provided downstream of the conveyance path 28 and accumulates a plurality of placed sheets for each copy, and a binding processing mechanism 47 that performs a binding process on the accumulated sheet bundle. Further, the processing portion B1 performs a binding process on the sheet bundle placed on the processing tray 37. The binding processing mechanism 47 is disposed below the conveyance path 28 in the vertical direction. As illustrated in FIG. 2, a step is formed in the first discharge path 31, and the processing tray 37 is disposed below the step. A first switchback path in which the sheet is guided onto the processing tray 37 after reversing the conveyance direction in a state in which part of the sheet has been discharged onto the first tray 49 through the discharge port 31a of the first discharge path 31 is provided between the first discharge path 31 and the processing tray 37.

Specifically, in the first discharge path 31, an upper conveyance roller 41 and a lower conveyance roller 48 that nip and convey the sheet are provided. The upper conveyance roller 41 and the lower conveyance roller 48 constitute a discharge roller pair 42 serving as a discharge portion. The upper conveyance roller 41 is capable of coming into and out of contact with and from the lower conveyance roller 48, and the sheet can be conveyed in a direction toward the first tray 49 and a direction opposite to this direction in a state in which the sheet is nipped between the upper conveyance roller 41 and the lower conveyance roller 48. Further, the sheet can be conveyed toward the processing tray 37 through the first switchback path by the upper conveyance roller 41 and the lower conveyance roller 48.

In addition, the upper conveyance roller 41 and the lower conveyance roller 48 (that is, the discharge roller pair 42) discharge the sheet or sheet bundle on the processing tray 37 onto the first tray 49 serving as a stacking tray (stacking portion) through the discharge port 31a. The discharge port 31a is a portion opening at a position above the lower conveyance roller 48 in the housing 27. Further, the discharge roller pair 42 discharges the sheet conveyed to the first discharge path 31 without passing the processing tray 37 onto the first tray 49 through the discharge port 31a.

The binding processing mechanism 47 includes a trailing end regulating portion 47a that abuts an end portion (trailing end) of the sheet and positions the sheet. A reversing portion 38 that conveys the sheet conveyed to the processing tray 37 by the upper conveyance roller 41 and the lower conveyance roller 48 toward the trailing end regulating portion 47a is disposed on the processing tray 37. Further, the binding processing mechanism 47 performs a binding process on an end portion of a sheet bundle constituted by a plurality of sheets which are placed on the processing tray 37 and a position of an end portion of which is regulated by the trailing end regulating portion 47a. In addition, the binding processing mechanism 47 includes a sheet bundle discharge mechanism that discharges the sheet bundle onto the first tray 49 after performing the binding process on the end portion of the sheet bundle.

To be noted, the binding processing mechanism 47 illustrated in FIG. 2 supports the sheet conveyed from the first discharge path 31 such that the sheet bridges the processing tray 37 and the first tray 49 provided downstream thereof. That is, the sheet conveyed from the first discharge path 31 is supported such that the leading end portion of the sheet is supported on the uppermost sheet on the first tray 49 provided on the downstream side, and the trailing end portion of the sheet is supported on the processing tray 37.

### Saddle Path

The saddle path 32 for conveying the sheet to the saddle portion B2 described above is connected to the conveyance path 28, and the saddle path switching member 33 for guiding the sheet to the saddle path 32 is provided at the path branching portion thereof. The sheet guided to the saddle portion B2 through the saddle path 32 is subjected to the half-folding process, and after being subjected to the folding process, is discharged to the saddle discharge unit 131 via a post-folding path guide 114, a post-second roller path guide 116, a pre-clamp guide 119, and a saddle discharge guide 124. In the present embodiment, the saddle discharge guide 124 serving as a discharge guide portion is used as an auxiliary guide for appropriately stacking the sheet on the saddle discharge unit 131.

### Control Configuration

The outline of a control configuration of the image forming system 1000 will be described with reference to FIG. 3. First, the image forming apparatus A includes a controller 310, an operation portion 302, a conveyance controller 303, an image processing portion 304, a driving portion 305, and a communication portion 306. The controller 310 includes a central processing unit: CPU 311, a read-only memory: ROM 312, and a random access memory: RAM 313. The CPU 311 controls each component while reading out a program corresponding to a control procedure stored in the ROM 312. In addition, the RAM 313 stores work data and input data, and the CPU 311 performs control with reference to data stored in the RAM 313 on the basis of the program described above and the like.

The operation portion 302 is, for example, an operation panel provided in the image forming apparatus A and connected to the controller 310, and an operator operates the apparatus and performs various settings thereby. The conveyance controller 303 controls the various conveyance rollers that convey the sheet and the switching members that switch the conveyance path in the image forming apparatus A. The image processing portion 304 controls the image forming portion 3. The driving portion 305 controls various motors and the power source. The communication portion 306 communicably connects an external device 301 such as a personal computer and a communication portion 321 of the sheet processing apparatus B with the controller 310.

The sheet processing apparatus B includes a stacker controller 330, a conveyance controller 322, an end binding controller 323, a discharge process controller 324, and the communication portion 321. The stacker controller 330 includes a CPU 331, a ROM 332, and a RAM 333 similarly to the controller 310. The conveyance controller 322 controls the various conveyance rollers that convey the sheet and the switching members that switch the conveyance path in part of the sheet processing apparatus B other than the saddle portion B2. The end binding controller 323 controls the processing portion B1. The discharge process controller 324 controls various stacking trays onto which sheets are discharged and on which the discharged sheets are stacked. The communication portion 321 communicably connects the communication portion 306 of the image forming apparatus A and a communication portion 341 of the saddle portion B2 with the stacker controller 330. To be noted, the communication between the communication portion 306 and the communication portion 321 may be performed by wired communication or wireless communication.

The saddle portion B2 includes a saddle controller 350, a conveyance controller 342, a saddle binding controller 343, a half-folding controller 344, a square back process controller 345, and a communication portion 341. The saddle controller 350 includes a CPU 351, a ROM 352, and a RAM 353 similarly to the controller 310. The conveyance controller 342 controls the various conveyance rollers that convey the sheet and the switching members that switch the conveyance path in the saddle portion B2. The saddle binding controller 343 controls the saddle binding processing portion 104. The half-folding controller 344 controls a half-folding processing mechanism C1. The square back process controller 345 controls a square back processing unit C2. The communication portion 341 communicably connects the communication portion 321 of the sheet processing apparatus B with the saddle controller 350. To be noted, although a configuration in which the saddle controller 350 communicates with the stacker controller 330 via the communication portions 341 and 321 is employed in the present embodiment, a configuration in which each unit is controlled by the same controller may be employed. In addition, although the conveyance controller 322, the end binding controller 323, the discharge process controller 324, the stacker controller 330, and the saddle controller 350 are provided as elements that control the sheet processing apparatus B in the present embodiment, a configuration in which each unit is controlled by the same controller may be employed. In the present embodiment, the saddle controller 350 serves as an example of the controller described in the claims, but in the case where the same controller as the other controllers is used as described above, the same controller serves as an example of the controller described in the claims.

### Saddle Portion

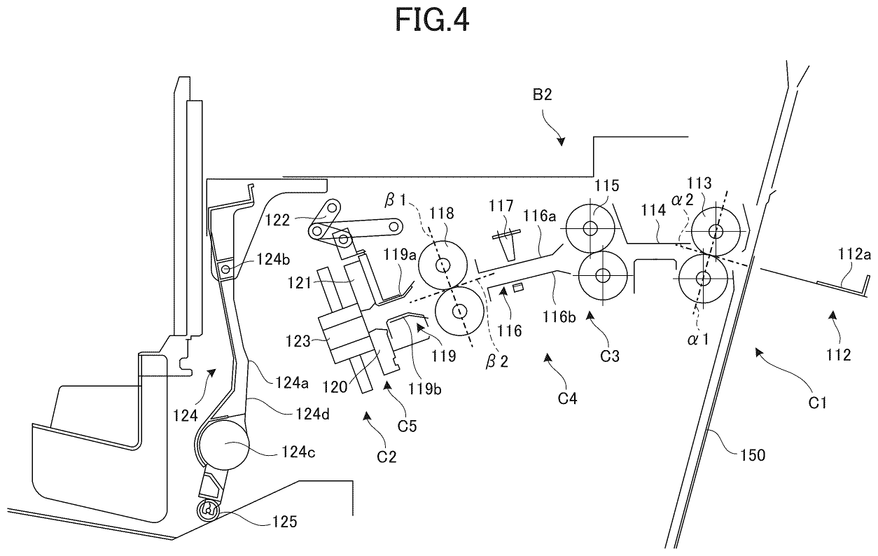

The saddle portion B2 will be described with reference to FIGS. 2 and 4. The saddle portion B2 includes the half-folding processing mechanism C1 and the square back processing unit C2. The half-folding processing mechanism C1 accumulates sheets conveyed from the conveyance path 28 for each copy to form a sheet bundle, performs a binding process on a center portion in the conveyance direction (center portion in a second conveyance direction that is a conveyance direction of the saddle path roller 100 serving as a second conveyance unit that will be described later) of the sheet bundle, and performs a half-folding process (hereinafter also referred to as a “magazine finish”) in which the sheet bundle is folded at a position subjected to the binding process. The square back processing unit C2 is disposed downstream of the half-folding processing mechanism C1 in the conveyance direction of the sheet bundle (downstream in the first conveyance direction that is the conveyance direction of a saddle third roller pair 118 serving as a first conveyance unit that will be described later), and performs a square back process of forming a folding line on the spine of the sheet bundle subjected to the half-folding process. Further, the saddle discharge unit 131 is disposed downstream of the square back processing unit C2 in the first conveyance direction, and the sheet bundle subjected to a bookbinding process is stacked on the saddle discharge unit 131. To be noted, only the half-folding process of folding the center portion of the sheet in the conveyance direction may be performed without performing the saddle binding process and the square back process after accumulating one sheet or a plurality of sheets for each copy.

### Half-Folding Mechanism

The half-folding processing mechanism C1 includes a leading end regulating stopper 109, a saddle binding processing portion (saddle binding stapling unit) 104 serving as a saddle binding processing unit, and a half-folding processing portion 112 serving as a half-folding processing unit, accumulates sheets into a bundle shape, and performs the half-folding process and the saddle binding process. That is, the sheet conveyed from the conveyance path 28 to the saddle path 32 is conveyed to the saddle stacking tray 150 serving as an accumulation portion and a second accumulation portion by the saddle path roller 100 serving as a second conveyance unit. The saddle stacking tray 150 forms a sheet bundle by accumulating a plurality of sheets conveyed in the second conveyance direction by the saddle path roller 100 through the saddle path 32. The sheet bundle accumulated on the saddle stacking tray 150 is positioned at a predetermined position on the saddle stacking tray 150 by the leading end regulating stopper 109. The saddle binding processing portion 104 performs the binding process on a center portion in the conveyance direction (middle portion in the second conveyance direction) of the sheet bundle positioned by the leading end regulating stopper 109. The half-folding processing portion 112 includes the folding plate 112a and the folding roller pair 113, and by conveying the sheet bundle by the folding roller pair 113 while poking the vicinity of the position subjected to the binding process by the saddle binding processing portion 104 (center portion in the conveyance direction of the sheet bundle in the binding process) by the folding plate 112a, the sheet bundle is folded and conveyed such that the spine of the sheet bundle is on the downstream side in the conveyance direction.

The saddle binding processing portion 104 is a mechanism that performs the binding process of moving a head unit and an anvil unit along the sheet center portion (line) while nipping the sheet bundle between the head unit and the anvil unit. In addition, for the half-folding processing portion 112, as illustrated in FIGS. 2 and 4, a configuration in which the sheet bundle is inserted in the nip of the folding roller pair 113 in pressure contact with each other by the folding plate 112a, and the sheet bundle is conveyed while being folded by the rotation of the folding roller pair 113 is employed.

### Square Back Processing Unit

The square back processing unit C2 performs, on the sheet bundle, the square back process to form a square back shape along the folding line of the sheet bundle subjected to the half-folding process, and includes a clamping mechanism C5 and a pressing roller unit 134. That is, the square back processing unit C2 includes a lower clamp unit 120 and an upper clamp unit 121 serving as a pair of clamping units, and a pressing roller 123. The lower clamp unit 120 and the upper clamp unit 121 relatively move along the thickness direction of the sheet bundle conveyed by a saddle third roller pair 118 that will be described later, and thus nip the sheet bundle and release the nipping of the sheet bundle. The pressing roller 123 moves along the width direction of the sheet bundle (direction orthogonal to the conveyance direction of the sheet bundle, front-rear direction of FIGS. 2 and 4), and thus presses the spine of the sheet bundle. Further, the square back processing unit C2 performs a square back process of forming a corner on the spine of the sheet bundle by pressing, by the pressing roller 123, the spine of the sheet bundle clamped between the lower clamp unit 120 and the upper clamp unit 121 in a state in which the spine of the sheet bundle protrudes downstream with respect to the lower clamp unit 120 and the upper clamp unit 121 in the first conveyance direction. To be noted, examples of the “corner” described above include a curved surface, and refers to a boundary between the front cover and the spine of the sheet bundle and a boundary between the spine and the back cover of the sheet bundle.

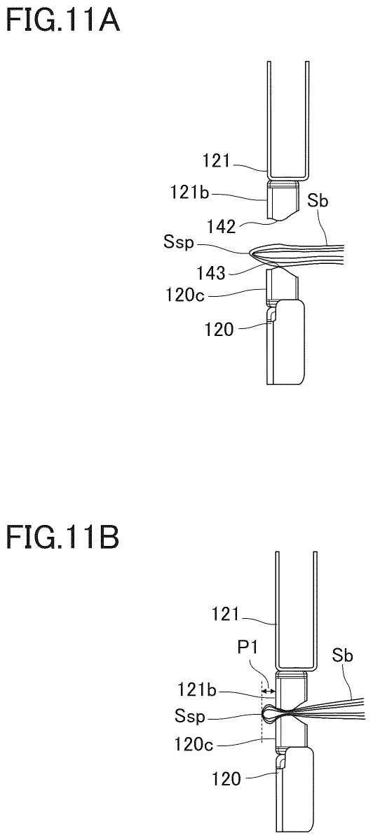

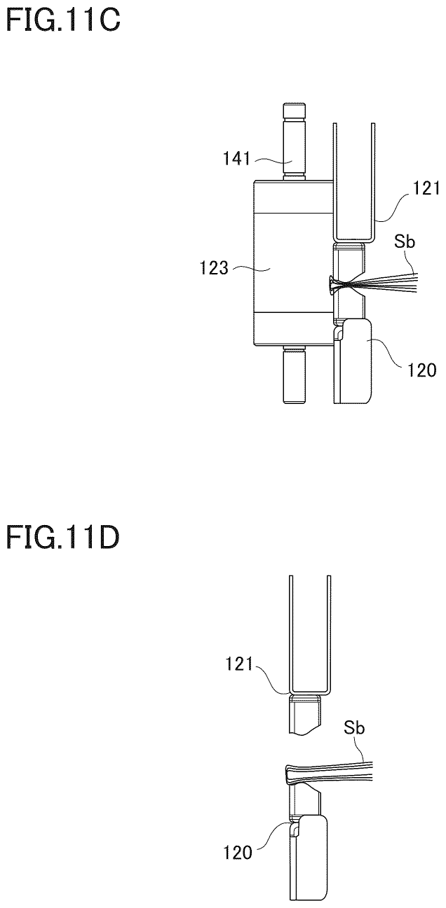

Specifically, the square back processing unit C2 nips part of the sheet bundle from both sides in the vertical direction (thickness direction of the sheet bundle) in a state in which the spine of the sheet bundle subjected to the half-folding by the half-folding processing mechanism C1 protrudes downstream in the first conveyance direction. The pressing roller 123 presses the spine of the sheet bundle clamped between the lower clamp unit 120 and the upper clamp unit 121 along the width direction of the sheet bundle orthogonal to the conveyance direction of the sheet bundle and to the thickness direction of the sheet bundle. In this manner, the square back processing unit C2 performs the square back process of forming a corner on the spine of the sheet bundle. The square back process is a process of forming two corners on the spine of the sheet bundle by forming two streaks on the spine of the sheet bundle as illustrated in FIGS. 11C and 11D by crushing the spine of the sheet bundle illustrated in FIGS. 11A and 11B that will be described later by the pressing roller 123. The two corners on the spine of the sheet bundle are formed at positions between which the staples embedded in the sheet bundle in the binding process by the saddle binding processing portion 104 are positioned in the thickness direction of the sheet bundle. In addition, the two corners formed on the spine of the sheet bundle are formed at positions between which a folding line formed in the half-folding process by the half-folding processing portion 112 is positioned.

To be noted, a half-folding conveyance mechanism that conveys the sheet bundle subjected to the half-folding process by the half-folding processing mechanism C1 to the square back processing unit C2 positioned downstream and stops the conveyance is disposed between the half-folding processing mechanism C1 and the square back processing unit C2.

As described above, the processing portion B1 and the conveyance path 28 are arranged in approximately the horizontal direction, the saddle path 32 that guides the sheet to the saddle portion B2 is disposed in approximately the vertical direction, and the saddle stacking tray 150 that accumulates the sheets for each copy is disposed to approximately follow the vertical direction. As described above, by disposing the conveyance path 28 along a direction traversing the housing 27 and disposing the saddle path 32 and the saddle portion B2 along approximately the vertical direction, the apparatus can be made slimmer, that is, the width of the apparatus in the horizontal direction can be reduced.

The saddle discharge unit 131 is disposed downstream of the saddle portion B2 in the conveyance direction of the sheet bundle, and accommodates a sheet bundle folded into a magazine shape. The saddle discharge unit 131 that is illustrated is disposed below the first tray 49 in the vertical direction. This is because the apparatus has specifications set in consideration of the fact that the frequency of use of the first tray 49 is higher than the frequency of use of the saddle discharge unit 131 and the first tray 49 is set to a height where the sheet on the tray is easy to pick up.

### Configuration of Saddle Portion

Next, the configuration of each of the half-folding processing mechanism C1, the half-folding conveyance mechanism C3, and the square back processing unit C2 constituting the saddle portion B2 will be described in more detail.

### Details of Half-Folding Processing Mechanism

As illustrated in FIG. 2, the saddle path switching member 33 is switched so as to convey the sheet to the saddle path 32, and thus guides the sheet to the half-folding processing mechanism C1. A saddle inlet roller 101, a sorting portion 102, a trailing end pressing guide 103, a saddle binding processing portion 104, a pull-in separation roller 105, a half-folding processing portion 112, a first alignment roller 107, a second alignment roller 108, a leading end regulating stopper 109, and a leading end gripper 110 are disposed in this order from the upper side (upstream side) in the vertical direction that is the inlet side in the height direction of the half-folding processing mechanism C1.

The saddle inlet roller 101 conveys the sheet passed on thereto from the saddle path 32 by the saddle path roller 100 further downward. The sorting portion 102 moves the sheet conveyed downward from the saddle inlet roller 101 to the right side in FIG. 2, and accumulates the sheet on the saddle stacking tray 150. The trailing end pressing guide 103 presses the trailing end of the sheet stacked on the saddle stacking tray 150. The saddle binding processing portion 104 performs the binding process on the center portion in the conveyance direction of the sheet bundle accumulated on the saddle stacking tray 150. The pull-in separation roller 105 supports the conveyance of the sheet conveyed to the saddle stacking tray 150, and is a roller that pulls in this sheet toward the leading end regulating stopper 109. The pull-in separation roller 105 is disposed so as to be capable of coming into contact and out of contact with and from an opposing roller 105a.

The half-folding processing portion 112 includes a folding roller pair 113, the folding plate 112a serving as a pressing portion, and a roller guide 111. The folding roller pair 113 forms a folding line in the half-folding process. The folding plate 112a pushes the sheet into the nip portion of the folding roller pair 113. The roller guide 111 covers the folding roller pair 113. The first alignment roller 107 and the second alignment roller 108 convey the sheet conveyed to the saddle stacking tray 150, and aligns the sheet in the height direction of the sheet. The leading end regulating stopper 109 abuts the leading end (lower end) of the sheet conveyed thereto, and determines the position of the leading end of the sheet in the height direction. The leading end gripper 110 presses the leading end (lower end) of the sheet stacked on the leading end regulating stopper 109.

The saddle inlet roller 101 and the pull-in separation roller 105 are driven by the same motor. The trailing end pressing guide 103 is provided at a position opposing the sorting portion 102 with the saddle stacking tray 150 therebetween. The saddle binding processing portion 104 is disposed at a position downstream of the sorting portion 102 and the trailing end pressing guide 103 and upstream of the pull-in separation roller 105.

The sheet conveyed from the saddle path 32 to the saddle portion B2 is conveyed to the leading end regulating stopper 109 moved to a position corresponding to the size by the saddle inlet roller 101. The pull-in separation roller 105 has an auxiliary conveyance function for precisely conveying the conveyed sheet to the leading end regulating stopper 109 in the saddle stacking tray 150. The roller guide 111 covers the folding roller pair 113 so as to suppress the leading end of the sheet getting caught at the folding roller pair 113 at this time and efficiently convey the sheet.

The first alignment roller 107 and the second alignment roller 108 cause the conveyed sheet to precisely abut the leading end regulating stopper 109, and thus performs an alignment process in the sheet height direction.

The sorting portion 102 moves the sheet conveyed to the leading end regulating stopper 109 to the trailing end pressing guide 103, and by pressing the trailing end (upper end) of the moved sheet by the trailing end pressing guide 103, preparation for receiving the next sheet is performed. At this time, the trailing end pressing guide 103 has moved to a position corresponding to the size and is standing by.

The leading end (trailing end) of the sheet bundle formed by stacking a plurality of sheets on the saddle stacking tray 150 is fixed by being gripped by the leading end gripper 110. In this state, the binding process is performed on the center portion in the second conveyance direction of the sheet bundle by the saddle binding processing portion 104. After the binding process, the leading end regulating stopper 109 is moved down while the leading end (lower end) of the sheet bundle is still gripped by the leading end gripper 110. At this time, by moving down the leading end regulating stopper 109 such that the position in the sheet where the sheet is pushed into the folding roller pair 113 by the folding plate 112a is a position of ½ of the sheet size, the sheet bundle is moved down from the binding position.

When performing the half-folding process, the roller guide 111 is retracted, the fixation by the leading end gripper 110 is released, and then the center portion of the sheet bundle is pushed into the nip portion of the folding roller pair 113 by the folding plate 112a. As a result of this, the half-folding process is performed on the sheet bundle.

The saddle inlet roller 101, the pull-in separation roller 105, the sorting portion 102, and the trailing end pressing guide 103 are controlled by the conveyance controller 342 (FIG. 3). In addition, the leading end regulating stopper 109, the leading end gripper 110, the saddle binding processing portion 104, the first alignment roller 107, and the second alignment roller 108 are controlled by the saddle binding controller 343 (FIG. 3). Further, the folding roller pair 113 and the folding plate 112a are controlled by the half-folding controller 344 (FIG. 3).

### Half-Folding Conveyance Mechanism

The configuration of the half-folding conveyance mechanism C3 will be described with reference to FIGS. 2 and 4. The half-folding conveyance mechanism C3 is a mechanism that passes on the sheet bundle subjected to the half-folding process by the half-folding processing mechanism C1 to the square back processing unit C2. Specifically, the half-folding conveyance mechanism C3 first conveys the sheet bundle subjected to the half-folding process as it is by the folding roller pair 113 such that the spine of the sheet bundle is positioned downstream of the fore edge in the conveyance direction, and passes on the sheet bundle to the post-folding path guide 114. The post-folding path guide 114 is disposed at a position downstream of the folding roller pair 113 in the conveyance direction and is disposed along a direction (approximately horizontal direction herein) bending downward in the vertical direction from a folding roller conveyance direction 113c (FIG. 2) following a line (first virtual line α2 that will be described later, FIG. 4) perpendicular to a straight line passing through the rotational center of each roller of the folding roller pair 113 serving as a first conveyance roller pair.

Here, as illustrated in FIG. 4, a straight line orthogonal to a first line α1 passing through the rotational centers of the folding roller pair 113 and to the width direction (direction orthogonal to the conveyance direction of the sheet bundle, front-rear direction of FIGS. 2 and 4) and passing through the nip of the folding roller pair 113 not nipping the sheet bundle is set as the first virtual line α2. In this case, the folding roller pair 113 is disposed such that the first virtual line α2 is parallel to the horizontal direction or is inclined upward in the vertical direction toward the downstream side in the conveyance direction with respect to the horizontal direction. In the present embodiment, the first virtual line α2 is inclined upward in the vertical direction toward the downstream side in the conveyance direction with respect to the horizontal direction. In contrast, the post-folding path guide 114 is provided to extend in a direction inclined with respect to the first virtual line α2, and is provided to extend approximately in the horizontal direction in the present embodiment.

The post-folding path guide 114 guides the conveyance of the sheet bundle, and guides the sheet bundle to a saddle second roller pair 115 positioned on the downstream side in the conveyance direction. A saddle second roller conveyance direction 115c that is a direction following a line perpendicular to a straight line passing through the rotational center of each roller of the saddle second roller pair 115 is provided along a direction inclined downward in the vertical direction toward the downstream side in the conveyance direction. The saddle second roller pair 115 is driven by the half-folding controller 344 and conveys the sheet bundle.

The sheet bundle conveyed by the saddle second roller pair 115 is passed on to the post-second roller path guide 116 disposed on the downstream side in the conveyance direction and disposed parallel to the saddle second roller conveyance direction 115c (FIG. 2), and is guided by the post-second roller path guide 116. In addition, the post-second roller path guide 116 includes a post-second roller path upper guide 116a that guides the upper surface of the sheet bundle and a post-second roller path lower guide 116b that guides the sheet bundle. A saddle conveyance sensor 117 is disposed at a position above the guide surface of the post-second roller path upper guide 116a and between the inlet port for the sheet bundle and the discharge port for the sheet bundle. The saddle conveyance sensor 117 detects the position of the leading end of the sheet bundle.

The post-second roller path guide 116 guides the conveyance of the sheet, and guides the sheet to the saddle third roller pair 118 positioned downstream in the conveyance direction. A saddle third roller conveyance direction 118c (FIG. 2) that is a direction following a line (second virtual line β2 that will be described next, FIG. 4) perpendicular to a straight line passing through the rotational center of each roller of the saddle third roller pair 118 is provided along a direction inclined downward in the vertical direction toward the downstream side in the conveyance direction.

The saddle third roller pair 118 serving as a conveyance unit and a conveyance roller pair is driven by the half-folding controller 344, and nips and conveys the sheet bundle subjected to the saddle binding process and the half-folding process such that the spine of the sheet bundle is positioned downstream of an end portion on the fore edge side in the conveyance direction. That is, the saddle third roller pair 118 conveys the sheet bundle such that the spine of the sheet bundle serves as the leading end. In the case where the direction in which the sheet bundle is conveyed by the saddle third roller pair 118 also serving as a first conveyance unit is set as the first conveyance direction (saddle third roller conveyance direction 118c), the saddle path roller 100 serving as a second conveyance unit that conveys the sheet to the half-folding processing mechanism C1 is positioned upstream of the saddle third roller pair 118 in the first conveyance direction. Further, the saddle path roller 100 conveys the sheet in a second conveyance direction different from the first conveyance direction at a position upstream of the saddle third roller pair 118 in the first conveyance direction. In the description below, the upstream side and the downstream side in the first conveyance direction (saddle third roller conveyance direction 118c) in which the sheet bundle is conveyed by the saddle third roller pair 118 may be sometimes simply referred to as the “upstream side” and the “downstream side”.

To be noted, the folding roller pair 113, the saddle second roller pair 115, and the saddle third roller pair 118 are driven by the same motor, and the half-folding controller 344 controls this motor to control the driving of each roller pair. The saddle third roller pair 118 nips the sheet bundle subjected to half-folding by the half-folding processing portion 112, conveys the sheet bundle toward the square back processing unit C2, and is positioned immediately upstream of the square back processing unit C2.

Here, as illustrated in FIG. 4, a straight line that is orthogonal to a second line β1 passing through the rotational centers of the saddle third roller pair 118 and to the width direction and that passes the nip of the saddle third roller pair 118 not nipping the sheet bundle is set as a second virtual line β2. In this case, the saddle third roller pair 118 is provided such that the second virtual line β2 intersects with the first virtual line α2 and is inclined downward in the vertical direction toward the downstream side of the folding roller pair 113 in the conveyance direction.

In other words, the saddle third roller pair 118 is disposed such that the second virtual line β2 is inclined downward in the vertical direction toward the downstream side in the conveyance direction with respect to the horizontal direction. That is, in the present embodiment, the second virtual line β2 is inclined with respect to the first virtual line α2. Further, the folding roller pair 113 conveys the sheet bundle in the horizontal direction or a direction (folding roller conveyance direction 113c) inclined upward in the vertical direction toward the downstream side in the conveyance direction with respect to the horizontal direction. In contrast, the saddle third roller pair 118 conveys the sheet bundle in a direction (saddle third roller conveyance direction 118c) inclined downward in the vertical direction toward the downstream side in the conveyance direction with respect to the horizontal direction.

Therefore, in the case of the present embodiment, the half-folding conveyance path C4 serving as a third conveyance path in which the sheet bundle is conveyed between the folding roller pair 113 and the saddle third roller pair 118 is bent such that the sheet bundle conveyed by the folding roller pair 113 is passed on to the saddle third roller pair 118. That is, the half-folding conveyance path C4 includes the post-folding path guide 114 and the post-second roller path guide 116, and the conveyance path between the post-folding path guide 114 and the post-second roller path guide 116 is bent. In other words, the direction in which the sheet bundle is guided by the post-second roller path guide 116 is inclined with respect to the direction in which the sheet bundle is guided by the post-folding path guide 114.

As described above, by making the conveyance direction of the sheet bundle by the folding roller pair 113 and the conveyance direction of the sheet bundle by the saddle third roller pair 118 different and bending the conveyance path between the post-folding path guide 114 and the post-second roller path guide 116, the width (length in the second conveyance direction, length in the left-right direction of FIG. 2) of the sheet processing apparatus B can be reduced, and thus the apparatus can be miniaturized. In addition, by discharging the sheet bundle downward by the saddle third roller pair 118 with the folding roller conveyance direction 113c serving as the sheet conveyance direction of the saddle third roller pair 118 directed diagonally downward, the sheet bundle processed by the saddle portion B2 can be discharged to a position lower in the apparatus. As a result of this, the saddle discharge unit 131 to which the sheet bundle processed by the saddle portion B2 is discharged can be disposed in a lower portion of the apparatus, and thus the amount by which the first tray 49 positioned above the saddle discharge unit 131 can be moved down can be increased. As a result of this, the sheet stacking amount of the first tray 49 can be increased. To be noted, in the case where “horizontal”, “vertical”, “parallel”, and the like are mentioned in the layout of the conveyance path guides for the sheet or sheet bundle and the conveyance direction of the sheet or sheet bundle, cases where an angle is formed with respect to the horizontal direction, the vertical direction, or the parallel direction due to the tolerance or the like are also included.

### Details of Square Back Processing Unit

The square back processing unit C2 will be described by using FIGS. 5 to 10 with reference to FIGS. 2 and 4. As described above, the lower clamp unit 120 and the upper clamp unit 121 serving as a pair of clamping units and the pressing roller 123 are provided. The clamping mechanism C5 including the lower clamp unit 120 and the upper clamp unit 121 includes a pre-clamp guide 119 as illustrated in FIG. 5. The pre-clamp guide 119 is disposed at a position downstream of the saddle third roller pair 118 in the conveyance direction and is disposed along a direction bent downward in the vertical direction with respect to the saddle third roller conveyance direction 118c, and guides the conveyance of the sheet bundle.

The pre-clamp guide 119 includes a pre-clamp upper guide portion 119a serving as a first guide portion that guides the upper surface of the sheet bundle, and a pre-clamp lower guide portion 119b serving as a second guide portion that guides the lower surface of the sheet bundle. The pre-clamp upper guide portion 119a and the pre-clamp lower guide portion 119b are disposed at positions apart from a line centered on the saddle third roller conveyance direction 118c by a distance larger than a half of the maximum thickness of the sheet bundle that can be passed through the apparatus (the thickness of the sheet bundle after performing the half-folding process on the sheet bundle of the maximum thickness that can be conveyed in the apparatus). That is, the distance between the pre-clamp upper guide portion 119a and the pre-clamp lower guide portion 119b is larger than the maximum thickness of the sheet bundle that can be processed by the sheet processing apparatus B (maximum thickness of the sheet bundle that can be subjected to the half-folding process by the half-folding processing mechanism C1). To be noted, at least one of the pre-clamp upper guide portion 119a and the pre-clamp lower guide portion 119b may be omitted.

That is, the lower clamp unit 120 and the upper clamp unit 121 are relatively movable to a first position where the sheet bundle conveyed from the saddle third roller pair 118 can be received and a second position where the sheet bundle is clamped. Further, the lower clamp unit 120 and the upper clamp unit 121 move from the first position to the second position and thus nip part of the sheet bundle from both sides in the thickness direction of the sheet bundle.

In the case of the present embodiment, the upper clamp unit 121 serving as a first clamp portion is movable, and the lower clamp unit 120 serving as a second clamp portion is fixed. That is, the upper clamp unit 121 moves in a direction to approach the lower clamp unit 120, and thus the sheet bundle is clamped. To be noted, a configuration in which the upper clamp unit 121 is fixed and the lower clamp unit 120 is movable may be employed, and a configuration in which both of these are movable may be employed. In either case, an upper clamping surface (upper clamping pressing portion) 142 of the upper clamp unit 121 that is a surface opposing the lower clamp unit 120 and a lower clamping surface (lower clamping pressing portion) 143 of the lower clamp unit 120 that is a surface opposing the upper clamp unit 121 nip the sheet bundle (see FIGS. 5 and 11A to 11D).

The lower clamping surface 143 of the lower clamp unit 120 and the upper clamping surface 142 of the upper clamp unit 121 are respectively parallel to the pre-clamp upper guide portion 119a and the pre-clamp lower guide portion 119b and are disposed downstream of the pre-clamp guide 119 in the conveyance direction of the sheet bundle. Further, the sheet bundle conveyed while being guided by the pre-clamp guide 119 is conveyed by a predetermined amount while further being guided by the upper clamping surface 142 and the lower clamping surface 143. To be noted, the pre-clamp lower guide portion 119b and the pre-clamp upper guide portion 119a are respectively fixed to the lower clamp unit 120 and the upper clamp unit 121. In the present embodiment, the pre-clamp upper guide portion 119a moves approximately in the vertical direction (thickness direction of the sheet bundle) together with the upper clamp unit 121.

### Pressing Roller Unit

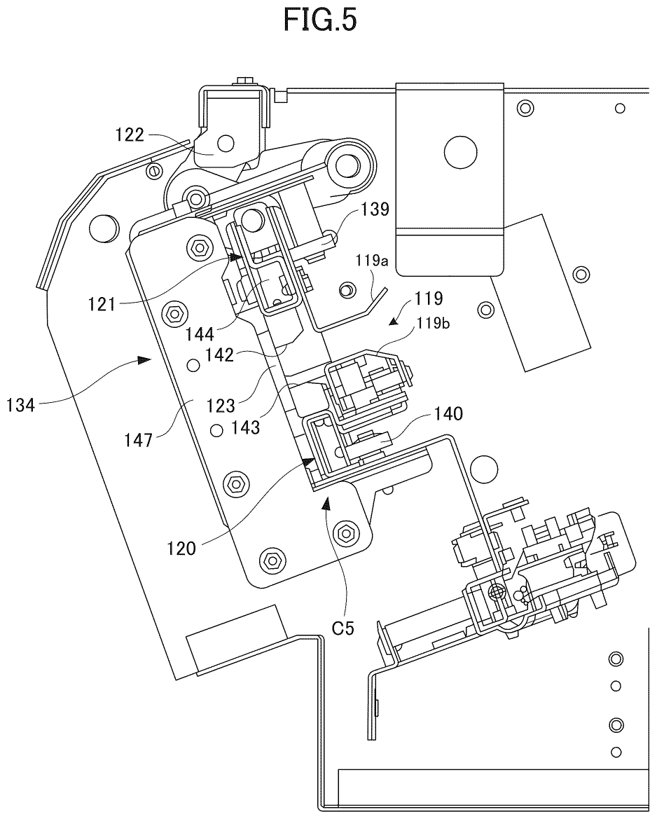

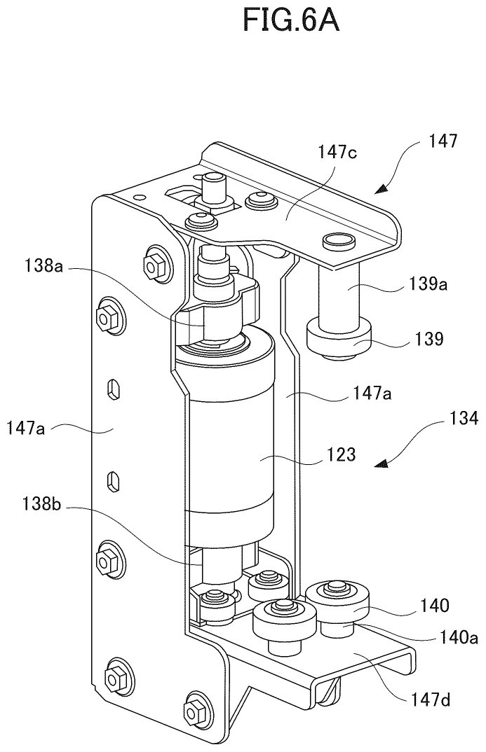

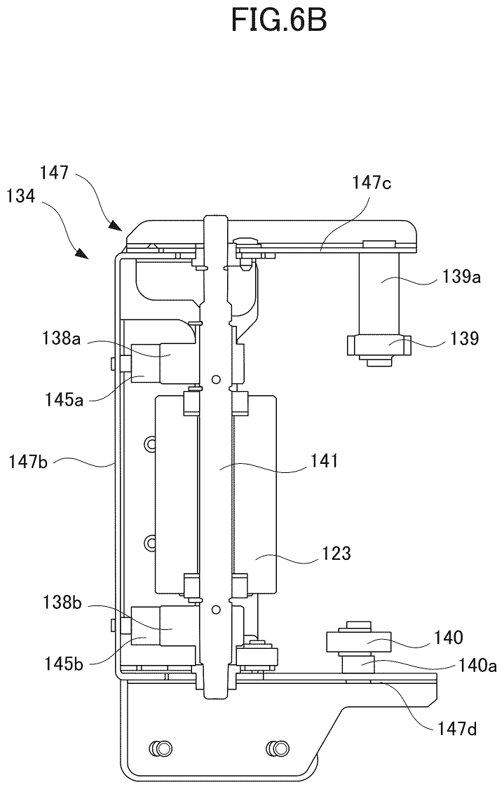

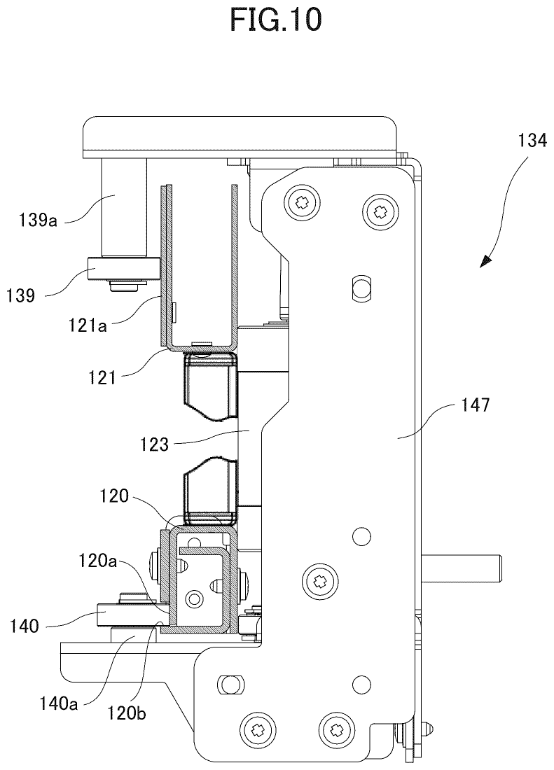

Next, an inner configuration of the pressing roller unit 134 will be described with reference to FIGS. 5 to 10. The pressing roller unit 134 includes, as elements for supporting and moving the pressing roller (square back processing roller) 123, a unit frame 147, roller pressurizing portions 138a and 138b, pressurizing springs 145a and 145b, an upper movement regulating portion 139, and a lower movement regulating portion 140. The pressing roller 123 is disposed such that the outer peripheral surface thereof is in contact with a downstream end surface of each of the lower clamp unit 120 and the upper clamp unit 121 as illustrated in FIGS. 5 and 10. In addition, a roller shaft 141 is disposed on the radially inner side of the pressing roller 123, and the pressing roller 123 is rotatable with respect to the roller shaft 141 as illustrated in FIG. 6B.

As illustrated in FIGS. 6A and 6B, the unit frame 147 includes a pair of side plates 147a disposed on the two sides of the pressing roller 123, a rear side plate 147b disposed on the left side of the downstream side (FIG. 6B) in the first conveyance direction of the pressing roller 123, and an upper side plate 147c and a lower side plate 147d that are provided on the two sides of the pressing roller 123 in the rotational axis direction so as to be bent from two end portions of the rear side plate 147b. The unit frame 147 is configured in this manner, and thus accommodates the pressing roller 123 in a space enclosed by the side plates and exposes the pressing roller 123 on the upstream side in the first conveyance direction.

In the present embodiment, the rear side plate 147b, the upper side plate 147c, and the lower side plate 147d are formed integrally, and has an approximate C shape in section view as illustrated in FIG. 6B. To be noted, these may be formed as separate members, or may be formed integrally with the pair of side plates 147a. The two end portions of the roller shaft 141 of the pressing roller 123 are respectively rotatably supported by the upper side plate 147c and the lower side plate 147d. In addition, the upper side plate 147c and the lower side plate 147d are provided to extend upstream of the pressing roller 123 in the first conveyance direction, and the upper movement regulating portion 139 and the lower movement regulating portion 140 are respectively supported at distal end portions of the upper side plate 147c and the lower side plate 147d.

That is, the upper movement regulating portion 139 is provided at a distal end portion of a support shaft 139a fixed to the upper side plate 147c and provided to extend downward from the upper side plate 147c. In addition, the lower movement regulating portion 140 is provided at a distal end portion of a support shaft 140a fixed to the lower side plate 147d and provided to extend upward from the lower side plate 147d. In addition, the upper movement regulating portion 139 is a roller rotatably provided at the distal end portion of the support shaft 139a, and the lower movement regulating portion 140 is a roller rotatably provided at the distal end portion of the support shaft 140a. To be noted, although two lower movement regulating portions 140 are provided side by side in the present embodiment, the number of the lower movement regulating portions 140 may be one. In addition, two upper movement regulating portions 139 may be also provided. The upper movement regulating portion 139 and the lower movement regulating portion 140 are positioned on the respective sides of the pressing roller 123 in the rotational axis direction of the roller shaft 141.

The roller pressurizing portions 138a and 138b are each coupled to the roller shaft 141 from the outside in the roller thickness direction of the pressing roller 123 and from the downstream side in the conveyance direction. Pressurizing springs 145a and 145b are disposed between the roller pressurizing portions 138a and 138b and the rear side plate 147b of the unit frame 147, and the roller shaft 141 is urged by the pressurizing springs 145a and 145b. The roller shaft 141 is configured to be movable in the conveyance direction, and therefore the pressurizing force by which the pressing roller 123 pressurizes the spine of the sheet bundle by the urging force of the pressurizing springs 145a and 145b changes in accordance with the change in the protruding amount of the spine of the sheet bundle from the lower clamp unit 120 and the upper clamp unit 121 that will be described later.

In addition, the pressing roller 123 is urged by the pressurizing springs 145a and 145b via the roller shaft 141, and is therefore pressurized by the lower clamp unit 120 and the upper clamp unit 121. In contrast, the upper movement regulating portion 139 and the lower movement regulating portion 140 are disposed on the opposite side to the pressing roller 123 across the lower clamp unit 120 and the upper clamp unit 121 so as to respectively oppose the lower clamp unit 120 and the upper clamp unit 121 (FIG. 5). That is, the upper movement regulating portion 139 and the lower movement regulating portion 140 are disposed on the upstream side of the lower clamp unit 120 and the upper clamp unit 121 in the conveyance direction of the sheet bundle (first conveyance direction) so as to respectively oppose the upper clamp unit 121 and the lower clamp unit 120.

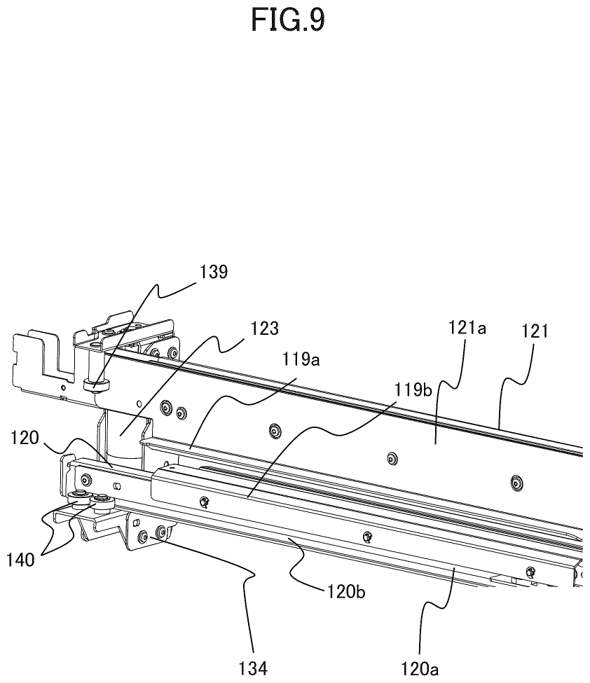

As illustrated in FIGS. 9 and 10, an end surface 120a on the upstream side of the lower clamp unit 120 is in contact with the lower movement regulating portion 140. In addition, an end surface 121a on the upstream side of the upper clamp unit 121 is in contact with the upper movement regulating portion 139. In the present embodiment, the lower movement regulating portion 140 and the upper movement regulating portion 139 are each a roller having a rotation shaft in a direction (up-down direction of FIG. 10, an approximately vertical direction in the present embodiment) orthogonal to the width direction of the sheet bundle and the conveyance direction of the sheet bundle, and respectively rotate in contact with the end surfaces 120a and 121a. As a result of this, upstream movement of the lower clamp unit 120 and the upper clamp unit 121 caused by the pressurizing force applied from the pressing roller 123 to the lower clamp unit 120 and the upper clamp unit 121 is restricted.

The conveyance amount of the sheet bundle conveyed by the saddle third roller pair 118 is counted by the square back process controller 345 when the leading end of the sheet bundle is detected by the saddle conveyance sensor 117 described above, and the sheet bundle is stopped after being conveyed by a predetermined conveyance amount. Specifically, as illustrated in FIG. 11A that will be described later, the sheet bundle is stopped in a state in which the spine of the sheet bundle subjected to the half-folding protrudes downstream in the conveyance direction more than the upper clamp unit 121 and the lower clamp unit 120. In the present embodiment, in the square back process, the conveyance amount of the sheet bundle by the saddle third roller pair 118 is controlled, and thus the protruding amount of the spine of the sheet bundle from the upper clamp unit 121 and the lower clamp unit 120 is adjusted.

### Upper Clamp Unit and Lower Clamp Unit

The upper clamp unit 121 moves from a receiving position (first position) for receiving the sheet bundle to a clamp holding position (second position) for holding the sheet bundle, thus the sheet bundle is pressurized between the upper clamp unit 121 and the lower clamp unit 120, and the sheet bundle is held by the upper clamping surface 142 and the lower clamping surface 143. At this time, the leading end of the sheet bundle protrudes by a predetermined protruding amount P1 from respective end surfaces 120c and 121b on the downstream side of the lower clamp unit 120 and the upper clamp unit 121 after the clamp holding in the conveyance direction as illustrated in FIG. 11B.

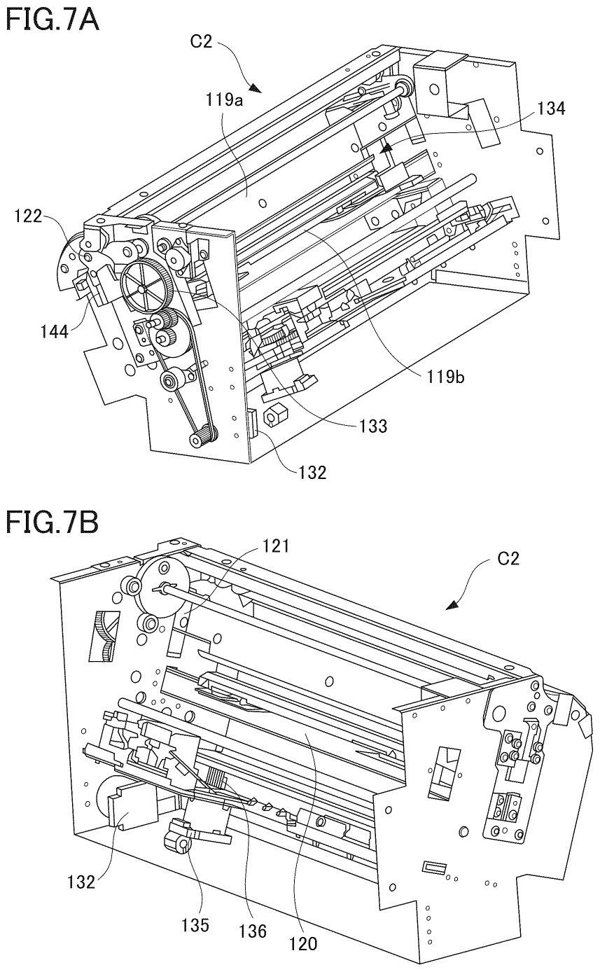

The upper clamp unit 121 operates by driving a clamp driving motor 132 (FIGS. 7A and 7B) by the square back process controller 345. As illustrated in FIGS. 7A and 7B, the square back processing unit C2 transmits a drive transmitted by a clamp driving train 133 constituted by a pulley, a belt, and a gear train further to a clamp driving link 122, and thus moves the upper clamp unit 121 connected to the clamp driving link 122 in the thickness direction of the sheet bundle. A plurality of clamp springs 144 that pressurize the sheet bundle are provided between the clamp driving link 122 and the upper clamp unit 121, and while the movement amount of the clamp driving link 122 remains constant, the contraction amount of the clamp spring 144 changes in accordance with the thickness of the sheet bundle, and thus the pressurizing force changes. The clamp holding position described above also changes in accordance with the thickness of the sheet bundle.

### Square Back Processing Unit

As illustrated in FIG. 11C that will be described later, the square back processing unit C performs the square back process on the sheet bundle held between the lower clamp unit 120 and the upper clamp unit 121 in a state of protruding from the end surfaces 120c and 121b by the predetermined protruding amount P1, by pressurizing the spine of the sheet bundle while moving, in the width direction of the sheet bundle in a scanning manner, the pressing roller 123 disposed on the downstream side in the conveyance direction.

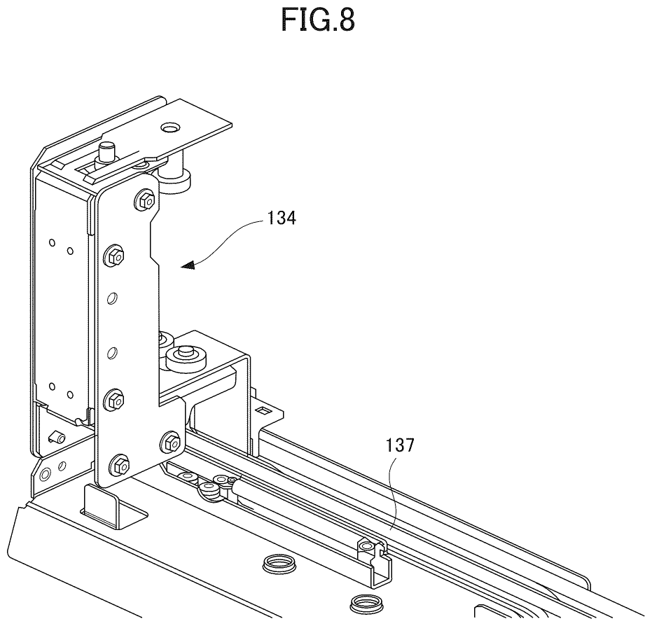

During the square back process, the pressing roller 123 is moved by operating a driving motor 135 (FIG. 7B) by the square back process controller 345. The pressing roller 123 is coupled to a driving belt 137 disposed in the width direction of the sheet bundle as illustrated in FIG. 8, and is movable in the width direction of the sheet bundle along a guide rail 120b illustrated in FIG. 9 that will be described later. The driving belt 137 rotates by receiving a driving force transmitted from the driving motor 135 via a driving train 136 (FIG. 7B) constituted by a gear train. As a result of this, the pressing roller 123 can be moved in a scanning manner in the width direction of the sheet bundle. To be noted, the home position of the pressing roller 123 is provided on the front side and rear side of the sheet processing apparatus B. That is, after the square back process is performed on the first sheet bundle by moving the pressing roller 123 from the rear side to the front side, the square back process can be performed on the second sheet bundle by moving the pressing roller 123 from the front side to the rear side. An unillustrated sensor is provided at each home position of the pressing roller 123, and thus the position of the pressing roller 123 can be detected. To be noted, a configuration in which the home position is provided at any one of the front side and the rear side and the scanning movement of the pressing roller 123 in the width direction is performed only from the front side to the rear side or from the rear side to the front side may be employed. In the case where the home position is provided at any one of the front side and the rear side, for example, after performing the square back process on the first sheet bundle by moving the pressing roller 123 from the rear side to the front side, the pressing roller 123 may be returned from the front side to the rear side and the square back process may be performed also on the second sheet bundle by moving the pressing roller 123 from the rear side to the front side.

In addition, in one square back process, the pressing roller 123 is moved in one direction from the front side to the rear side or from the rear side to the front side, but the pressing roller 123 may be reciprocated in one square back process. For example, whether the pressing roller 123 is moved in one direction or reciprocated may be set in accordance with the number of sheets included in the sheet bundle or the type of the sheet. This setting may be automatically performed by the controller, or may be performed by an operator such as a user or a service worker. Further, whether the pressing roller 123 is moved in one direction or reciprocated may be arbitrarily settable by the operator in each square back process.

The lower clamp unit 120 includes the guide rail 120b formed along the width direction of the sheet bundle as illustrated in FIGS. 9 and 10. The lower movement regulating portion 140 moves along the guide rail 120b in engagement with the guide rail 120b when the pressing roller 123 moves in the width direction of the sheet bundle. The guide rail 120b is formed in an approximate C shape in section view by combining a plurality of members as illustrated in FIG. 10 such that part of the lower movement regulating portion 140 formed in a roller shape can enter the guide rail 120b. The lower surface of the radially outer side of the lower movement regulating portion 140 is engaged with the lower surface of the guide rail 120b, and the outer peripheral surface of the lower movement regulating portion 140 is in contact with the end surface 120a. As a result of this, the movement in the sheet bundle thickness direction is restricted when the pressing roller 123 moves. To be noted, the guide rail 120b may be a groove formed in one member provided on the upstream side of the lower clamp unit 120 in the conveyance direction.

After the square back process is completed, the pressing roller 123 is moved in the width direction and is thus retracted from the conveyance path of the sheet bundle by operating the driving motor 135 (FIG. 7B), and the upper clamp unit 121 is moved in a direction away from the sheet bundle (FIG. 11D that will be described later) by operating the clamp driving motor 132 (FIGS. 7A and 7B). As a result of this, the sheet bundle can be further conveyed downstream. To be noted, the sheet bundle can be also discharged without performing the square back process described above.

### Discharge Portion

As illustrated in FIG. 2, the sheet bundle having passed the saddle portion B2 is conveyed toward the saddle discharge guide 124 disposed further downstream of the pressing roller 123 in the first conveyance direction, by the saddle third roller pair 118. The saddle discharge guide 124 is supported to be swingable about a first fulcrum 124b including a rotation shaft parallel to the rotational axis of each roller of the saddle third roller pair 118. The first fulcrum 124b is positioned above an extension line of the conveyance direction (first conveyance direction, saddle third roller conveyance direction 118c) of the sheet bundle by the saddle third roller pair 118. Further, the saddle discharge guide 124 is disposed to hang down in the vertical direction from the first fulcrum 124b.

In addition, the saddle discharge guide 124 is formed such that the side surface thereof on the upstream side in the first conveyance direction is inclined upstream in the first conveyance direction from the first fulcrum 124b toward a middle portion 124a in the vertical direction. In addition, the side surface of the saddle discharge guide 124 on the upstream side in the first conveyance direction is inclined downstream in the first conveyance direction from the middle portion 124a toward the lower end in the vertical direction. That is, the side surface of the saddle discharge guide 124 on the upstream side in the first conveyance direction is formed such that the middle portion 124a in the vertical direction protrudes upstream in the first conveyance direction as compared with the other part. Further, in the side surface of the saddle discharge guide 124 on the upstream side in the first conveyance direction, a guide surface 124d is provided in a portion from the middle portion 124a to the lower end.

The guide surface 124d is positioned below an extension line obtained of the saddle third roller conveyance direction 118c, comes into contact with the sheet bundle conveyed by the saddle third roller pair 118, and guides the sheet bundle downward. The saddle discharge guide 124 is capable of pivoting about the first fulcrum 124b when the sheet bundle comes into contact with the guide surface 124d. To be noted, depending on the stiffness of the sheet bundle, there is a case where the sheet bundle does not come into contact with the guide surface 124d of the saddle discharge guide 124, and even in the case where the contact occurs, since the amount of the pivot changes depending on the stiffness, the saddle discharge guide 124 does not necessarily pivot.

In addition, a second fulcrum 124c is provided at a lower end portion of the saddle discharge guide 124, and a saddle discharge roller 125 that will be described later is coupled to the lower end portion of the saddle discharge guide 124 so as to be pivotable about the second fulcrum 124c. The second fulcrum 124c is positioned below the guide surface 124d, and includes a pivot shaft parallel to the pivot shaft of the first fulcrum 124b.

When the sheet bundle continues to be conveyed by the saddle third roller pair 118, the sheet bundle is passed onto a saddle discharge unit 131 disposed downstream of the pressing roller unit 134 in the first conveyance direction and below the saddle discharge guide 124 in the vertical direction. The saddle discharge unit 131 includes a saddle discharge upstream belt 127, a saddle discharge upstream sensor 128, a saddle discharge downstream belt 129, and a saddle discharge downstream sensor 130.

The saddle discharge upstream belt 127 is positioned below the guide surface 124d of the saddle discharge guide 124, and guides and conveys the sheet bundle guided downward by the guide surface 124d further downstream. The saddle discharge upstream belt 127 is inclined downward in the vertical direction toward the downstream side in the conveyance direction. The saddle discharge downstream belt 129 serving as a sheet bundle discharge portion receives the sheet bundle conveyed from the saddle discharge upstream belt 127, and further guides and conveys the received sheet bundle downstream. The saddle discharge downstream belt 129 is inclined upward in the vertical direction toward the downstream side in the conveyance direction. Therefore, the sheet bundle guided to the saddle discharge upstream belt 127 by the guide surface 124d is conveyed by the saddle discharge upstream belt 127 in a direction inclined downward in the vertical direction, and is then conveyed by the saddle discharge downstream belt 129 in a direction inclined upward in the vertical direction.

In addition, the saddle discharge upstream sensor 128 that detects the sheet bundle on the upstream side is disposed on the upstream side in a conveyable region of the saddle discharge upstream belt 127, and the saddle discharge downstream sensor 130 that detects the sheet bundle on the downstream side is disposed on the upstream side in a conveyable region of the saddle discharge downstream belt 129.

The sheet bundle passed on to the saddle discharge unit 131 is guided and conveyed by the saddle discharge upstream belt 127 and the saddle discharge downstream belt 129, and is then stacked. The saddle discharge upstream belt 127 nips the sheet bundle at a nip point between the saddle discharge upstream belt 127 and the saddle discharge roller 125 described above on the downstream side in the conveyance direction. The sheet bundle present on the saddle discharge upstream belt 127 is configured to suppress opening on the opening portion side (fore edge side) at this nip point. The position of this nip point can change about a second fulcrum 124c in accordance with the thickness of the sheet bundle.

While the succeeding sheet bundle is processed, the preceding sheet bundle is conveyed upstream in the conveyance direction by the saddle discharge upstream belt 127, and is stopped after a predetermined conveyance amount since being detected by the saddle discharge upstream sensor 128 or the saddle discharge downstream sensor 130. The position where the preceding sheet bundle stops corresponds to a position where the opening on the opening portion side of the preceding sheet bundle can be suppressed at the nip point between the saddle discharge upstream belt 127 and the saddle discharge roller 125, and to a position where the succeeding sheet comes into contact with the upper surface of the preceding sheet bundle when being discharged. That is, in the present embodiment, the succeeding sheet bundle is stacked on the preceding sheet bundle (as in a shingled manner) in the saddle discharge unit 131.

As described above, the saddle discharge unit 131 discharges the succeeding sheet bundle onto the upper surface of the preceding sheet bundle without entering the opening portion of the preceding sheet bundle, and thus the sheet bundles are stably stacked in the shingled manner without occurrence of a failure such as getting caught by the preceding sheet bundle, getting curled against the preceding sheet bundle, or pushing out the preceding sheet bundle. That is, by appropriately changing the conveyance amount described above in accordance with the size of the sheet bundle, the succeeding sheet bundle can be stably stacked on the preceding sheet bundle.

The saddle discharge portion 126 is disposed at a position downstream of the saddle discharge guide 124 in the first conveyance direction and between the saddle discharge upstream belt 127 and the saddle discharge downstream belt 129. The sheet bundle conveyed to the saddle discharge unit 131 passes through the saddle discharge portion 126 to be discharged to the outside of the sheet processing apparatus B, and thus the user can easily access the discharged sheet bundle.

To be noted, in the case where another apparatus is present on the downstream side of the saddle discharge unit 131, the sheet bundle can be passed on to the downstream apparatus by continuing the conveyance without the stacking. In addition, in the present embodiment, a discharge cover 151 serving as a cover member is provided on the outside of the saddle discharge portion 126. The discharge cover 151 is disposed so as not to interrupt discharge of the sheet bundle from the saddle discharge portion 126 and such that an operator such as a user cannot access the inside of the apparatus through the saddle discharge portion 126.

### Control of Square Back Process

Next, the control of the square back process of the present embodiment will be described with reference to FIGS. 11 to 16. As described above, the square back processing unit C2 performs the square back process of forming a corner on the spine of the sheet bundle subjected to the saddle binding process and the half-folding process. In the present embodiment, a second mode for performing a stronger square back process on the sheet bundle can be executed in addition to a first mode that is a normal square back process. The half-folding controller 344 illustrated in FIG. 3 controls each conveyance roller pair of the folding roller pair 113, the saddle second roller pair 115, and the saddle third roller pair 118 by the same driving.

### First Mode

First, the first mode will be described with reference to FIGS. 11A to 11D. The first mode is a mode in which the pressing roller 123 is pressed against the spine of the sheet bundle Sb only once. The half-folding controller 344 conveys the sheet bundle Sb subjected to the half-folding to the gap between the upper clamp unit 121 and the lower clamp unit 120 in the separated state in response to detection of the leading end of the sheet bundle Sb by the saddle conveyance sensor 117. Then, as illustrated in FIG. 11A, the half-folding controller 344 stops the conveyance of the sheet bundle Sb in a state in which a spine Ssp of the sheet bundle Sb protrudes further downstream in the first conveyance direction than the end surfaces 121b and 120c on the downstream side in the first conveyance direction of the upper clamp unit 121 and the lower clamp unit 120.

In this state, the square back process controller 345 drives the clamp driving motor 132 (FIGS. 7A and 7B) and thus moves the upper clamp unit 121 toward the lower clamp unit 120, and as illustrated in FIG. 11B, the sheet bundle Sb is clamped by the upper clamp unit 121 and the lower clamp unit 120. At this time, the spine Ssp of the sheet bundle Sb protrudes further downstream than the end surfaces 121b and 120c on the downstream side in the first conveyance direction of the upper clamp unit 121 and the lower clamp unit 120 by P1.

Next, the square back process controller 345 operates the driving motor 135 (FIG. 7B), and thus moves the pressing roller 123 in the width direction of the sheet bundle Sb. At this time, as illustrated in FIG. 11C, the pressing roller 123 moves in the width direction while pressurizing the spine Ssp of the sheet bundle Sb, and thus the square back process is performed on the spine Ssp of the sheet bundle Sb. Then, as illustrated in FIG. 11D, the square back process controller 345 drives the clamp driving motor 132 (FIGS. 7A and 7B), thus separates the upper clamp unit 121 from the lower clamp unit 120, and releases the nipping of the sheet bundle Sb. In the first mode, the square back process is finished here, and the discharge operation of the sheet bundle Sb described above is performed.

### Second Mode

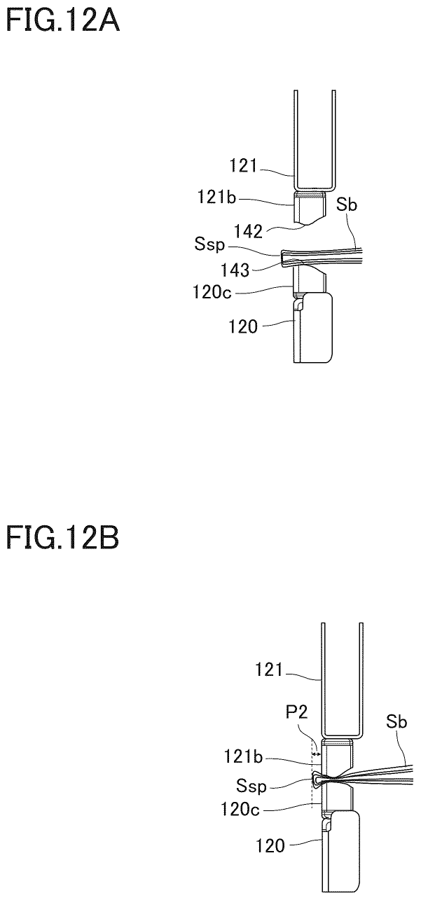

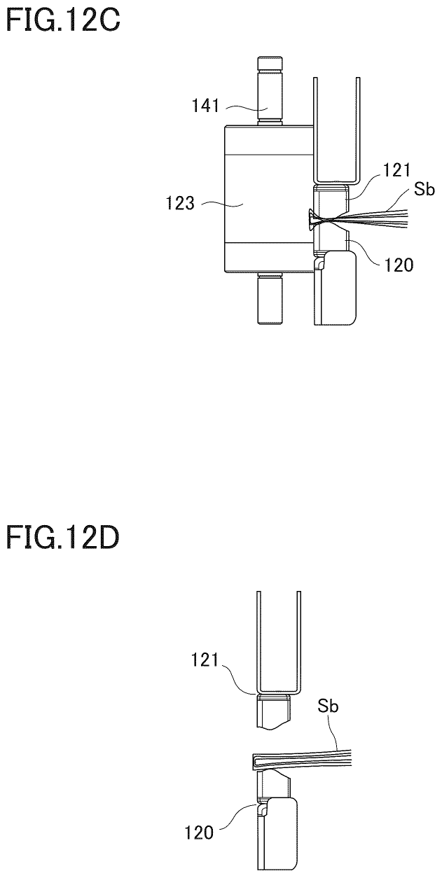

Next, the second mode will be described with reference to FIGS. 12A to 12D in addition to FIGS. 11A to 11D. The second mode is a mode in which the square back process is further performed on the spine Ssp of the sheet bundle Sb in addition to the first mode described above. That is, in the second mode, the sheet bundle Sb subjected to the square back process is conveyed downstream in the first conveyance direction by the saddle third roller pair 118, and the square back process is performed again. Specific description will be given. In the second mode, after the square back process of FIGS. 11A to 11D is performed, a second square back process is performed as illustrated in FIGS. 12A to 12D.

As illustrated in FIG. 11D described above, after the square back process is performed once on the sheet bundle Sb, the nipping of the sheet bundle Sb by the upper clamp unit 121 and the lower clamp unit 120 is released by moving up the upper clamp unit 121, and the upper clamp unit 121 is moved to a standby position. At the time of the first square back process, the pressing roller 123 moves from the front side to the rear side, and the pressing roller 123 is positioned at the home position on the rear side when the first square back process is finished.

Next, the saddle third roller pair 118 is driven by the half-folding controller 344, thus the sheet bundle Sb is conveyed further downstream as illustrated in FIG. 12A, and the conveyance of the sheet bundle Sb is stopped after the conveyance by a predetermined amount. In this state, the square back process controller 345 drives the clamp driving motor 132 (FIGS. 7A and 7B), thus the upper clamp unit 121 is moved toward the lower clamp unit 120, and the sheet bundle Sb is clamped by the upper clamp unit 121 and the lower clamp unit 120 as illustrated in FIG. 12B. At this time, the spine Ssp of the sheet bundle Sb protrudes more downstream by P2 than the end surfaces 121b and 120c on the downstream side in the first conveyance direction of the upper clamp unit 121 and the lower clamp unit 120.

At this time, the protrusion amount P2 of the spine Ssp of the sheet bundle Sb from the end surfaces 121b and 120c of the upper clamp unit 121 and the lower clamp unit 120 is set to be equal to or less than the distance of the protrusion amount P1 in the first square back process. That is, in the first square back process, the protrusion amount of the spine Ssp of the sheet bundle Sb clamped by the upper clamp unit 121 and the lower clamp unit 120 from the end surfaces 121b and 120c of the upper clamp unit 121 and the lower clamp unit 120 before the press by the pressing roller 123 is set as the first protrusion amount P1. In addition, in the second square back process, the protrusion amount of the spine Ssp of the sheet bundle Sb clamped by the upper clamp unit 121 and the lower clamp unit 120 from the end surfaces 121b and 120c of the upper clamp unit 121 and the lower clamp unit 120 before the press by the pressing roller 123 is set as the second protrusion amount P2. In this case, the second protrusion amount P2 is equal to the first protrusion amount P1, or smaller than the first protrusion amount P1, that is, equal to or smaller than the first protrusion amount (P2≤P1).

In the present embodiment, the protrusion amounts P1 and P2 described above are set by controlling the conveyance stop position of the sheet bundle Sb in the driving of the saddle third roller pair 118 by the half-folding controller 344. That is, as described above, the protrusion amounts P1 and P2 are adjusted by controlling the conveyance amount of the sheet bundle by the saddle third roller pair 118. To be noted, a stopper that abuts the spine of the sheet bundle may be disposed on the downstream side of the upper clamp unit 121 and the lower clamp unit 120, and the protrusion amount of the spine of the sheet bundle may be adjusted to P1 and P2 by changing the position of the stopper. To be noted, in the case where P1 and P2 are equal, the stopper may be configured such that the position thereof is not to be changed. In either of these, the stopper is movable to a position to abut the sheet bundle and a position retracted from this position.

Next, the square back process controller 345 moves the pressing roller 123 in the width direction of the sheet bundle Sb by operating the driving motor 135 (FIG. 7B). At this time, as illustrated in FIG. 12C, the pressing roller 123 moves along the width direction from the rear side to the front side while pressurizing the spine Ssp of the sheet bundle Sb, and thus the second square back process is performed on the spine Ssp of the sheet bundle Sb. That is, since the pressing roller 123 moves from the front side to the rear side in the first square back process and the pressing roller 123 has moved to the rear side at the start of the second time, the pressing roller 123 is moved from the rear side to the front side in the second square back process. To be noted, in the case where the pressing roller 123 moves from the rear side to the front side in the first time, the pressing roller 123 is moved from the front side to the rear in the second time. In addition, in the case where the home position is set only on one of the front side and the rear side, the pressing roller 123 returns to the home position each time the square back process is finished, and therefore the pressing roller 123 is moved from the same position for both the first time and the second time. That is, a configuration in which the pressing roller 123 is reciprocated in the first square back process and the pressing roller 123 is also reciprocated in the second square back process may be employed.

In the present embodiment, a mode in which the square back process can be executed a plurality of times (at least twice) is provided. Therefore, the protrusion amount of the spine Ssp of the sheet bundle Sb in each square back process can be reduced. In addition, since the square back process is performed again in a state in which the spine Ssp of the sheet bundle Sb subjected to the square back process once protrudes from the upper clamp unit 121 and the lower clamp unit 120, the square back process can be performed more strongly. Then, as illustrated in FIG. 12D, the square back process controller 345 drives the clamp driving motor 132 (FIGS. 7A and 7B) to move the upper clamp unit 121 away from the lower clamp unit 120, and thus release the nipping of the sheet bundle Sb. That is, after the second square back process is performed, the upper clamp unit 121 is moved up, and is thus separated from the sheet bundle Sb and moved to the standby position. Then, the discharge process described above is performed. To be noted, although the square back process is performed twice in the second mode of the present embodiment, the square back process may be performed three or more times. That is, although the first mode is a mode in which the square back process is performed only once on one sheet bundle, the second mode is a mode in which the square back process is performed a plurality of times on one sheet bundle, and the number of times the square back process is performed can be set appropriately as long as the number is plural. In addition, the number of times of the square back process may be selectable.

To be noted, in the square back process described above, if the protrusion amount of the spine of the sheet bundle from the end surfaces 121b and 120c of the upper clamp unit 121 and the lower clamp unit 120 is larger, the pressing force of the pressing roller 123 on the spine of the sheet bundle can be made stronger, and thus a stronger square back process shape can be formed. However, if the protrusion amount of the spine of the sheet bundle from the end surfaces 121b and 120c of the upper clamp unit 121 and the lower clamp unit 120 is too large, a big impact occurs and a damage (scratch, wrinkle) and the like are generated in the spine of the sheet bundle when the pressing roller 123 moves over an end portion (protrusion portion) of the spine of the sheet bundle in the case of moving the pressing roller 123 in a scanning manner along the lower clamp unit 120 and the upper clamp unit 121.

In the second mode described above, the protrusion amount of the spine of the sheet bundle of each time can be reduced and thus the damage caused when the pressing roller 123 moves onto the spine of the sheet bundle can be reduced, by executing the square back process twice instead of setting a large protrusion amount for once. That is, by setting the protrusion amount of the spine of the sheet bundle from the end surfaces 121b and 120c of the upper clamp unit 121 and the lower clamp unit 120 when performing the second square back process after performing the first square back process to P2(P2≤P1), the impact occurring the time when the pressing roller 123 moves over an end portion (protrusion portion) of the spine of the sheet bundle can be reduced.

In addition, the protrusion amount of the spine of the sheet bundle from the end surfaces 121b and 120c of the upper clamp unit 121 and the lower clamp unit 120 can be substantially increased as compared with a case of performing the square back process only once. That is, in the second mode, the spine of the sheet bundle is crushed once in the first square back process, the sheet bundle is further caused to protrude in this state in the second square back process, and therefore the protrusion amount in total for the two times is larger than in the case of performing the square back process only once. Therefore, a stronger square back process shape can be formed by executing the second mode.

As described above, in the present embodiment, occurrence of damage (scratch and wrinkle) to the spine of the sheet bundle can be suppressed by executing the second mode. In addition, opening of the sheet bundle after the folding process can be suppressed. In addition, the second mode takes a longer processing time than the first mode because the sheet bundle is clamped again and the second square back process is performed. Therefore, it is preferable that a high-productivity mode and a high-quality mode are prepared and an operator such as a user selectively uses these. For example, in the case where the high-productivity mode is selected, the first mode is made executable in the case of performing the square back process, and in the case where the high-quality mode is selected, the first mode and the second mode are made selectable and executable in the case of performing the square back process. In the description below, selection of the first mode and the second mode will be described.

### Mode Selection

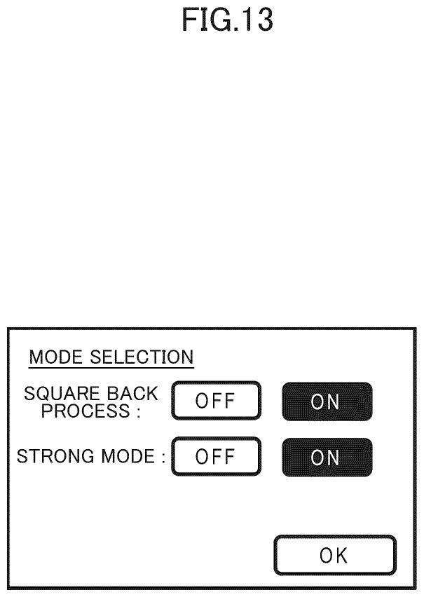

Selection of the first mode and the second mode described above will be described with reference to FIGS. 13 to 15. FIG. 13 is, for example, a UI screen displayed on a display portion such as a liquid crystal screen included in the operation portion 302 of the image forming system 1000, and illustrates a screen for mode selection. In the present embodiment, the display portion is a touch panel that can be operated by a hand or the like, and the mode selection screen is a screen that is displayed on the touch panel of the operation portion 302 and that can be operated by touch by an operator such as a user or a service person.

In the mode selection, first, “ON” or “OFF” of “SQUARE BACK PROCESS” is selected. Here, if ON is selected, a mode to execute the square back process is taken, and at this time, a state in which the first mode or the second mode is executable is taken. Next, “ON” of “OFF” of “STRONG MODE” is selected. Here, if ON is selected, the second mode is executed, and if OFF is selected, the first mode is selected. Then, if “OK” is selected, the mode is confirmed. FIG. 13 is a screen in the case where the square back process of the strong mode (second mode) is selected.

To be noted, in the case where the type of the sheet is not compatible with the second mode, the “STRONG MODE” may be made unselectable. For example, the selection screen of the “STRONG MODE” is hidden or grayed out. In addition, examples of the type of the sheet bundle not compatible with the second mode include a thin sheet bundle constituted by five sheets having a grammage of a predetermined value or less (80 g/m² or less). Examples of the type of the sheet bundle compatible with the second mode include a thick sheet bundle constituted by twenty-five sheets even if the grammage is equal to or smaller than the predetermined value (80 g/m² or less). The grammage of the sheet is, for example, set in advance by an operator such as a user via the operation portion 302 or the like for each of the cassettes 2a to 2d (FIG. 1). The saddle controller 350 obtains information of the grammage of the sheet in each cassette from the image forming apparatus A via the communication portion 341.

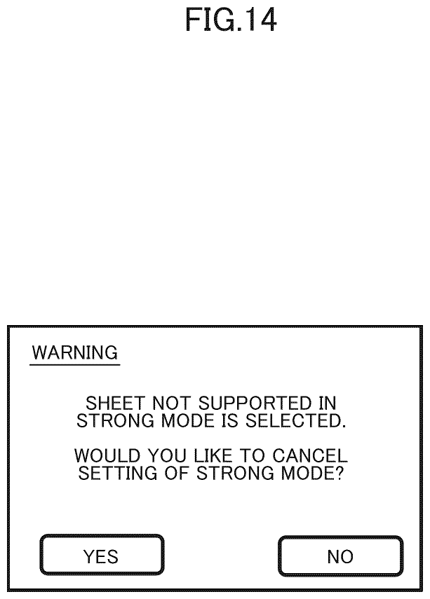

In the case of not hiding or graying out the screen of “STRONG MODE” for the sheet not compatible with the second mode, a warning screen illustrated in FIG. 14 may be displayed. That is, FIG. 14 is a warning screen in the case where the “STRONG MODE” is selected for the sheet not compatible with the second mode in the screen of FIG. 13. If the second mode is executed for the sheet not compatible with the second mode (for example, a sheet having a grammage of 80 g/m² or less), there is a possibility that the spine of the sheet bundle is crushed and the quality of the product deteriorates. Therefore, the second mode is preferably executed in the case where the grammage of the sheet included in the sheet bundle to be subjected to the square back process is more than the predetermined value, and the usability can be improved by displaying a warning when the second mode is selected in the case where the grammage of the sheet is equal to or less than the predetermined value.

In the case where the operator selects “NO” in the screen of FIG. 14, the second mode is forcibly executed, and in the case where “YES” is selected, the second mode is cancelled. In the case where the second mode is cancelled, the square back process may be executed in the first mode, or a screen to ask the user whether or not to execute the square back process may be displayed again.

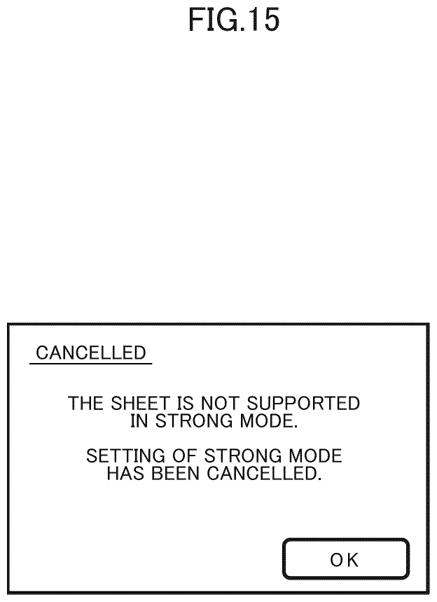

In contrast, in the case of not hiding or graying out the screen of the “STRONG MODE” for the sheet not compatible with the second mode, a cancelling screen of FIG. 15 may be displayed instead of the warning screen of FIG. 14. FIG. 15 is a screen for automatically cancelling the second mode in the case where the “STRONG MODE” is selected in the screen of FIG. 13 for the sheet not compatible with the second mode. In this screen, the second mode is automatically cancelled in response to the operator pressing “OK” in this screen. In this case, the square back process may be executed in the first mode, or a screen to ask the user whether or not to execute the square back process may be displayed again.

To be noted, as the screen displayed in the case where the “STRONG MODE” is selected for the sheet not compatible with the second mode in the screen of FIG. 13, not only the screen for automatic cancellation of FIG. 15, but also a screen prompting changing the type of the sheet set by the user to a type compatible with the second mode may be displayed. For example, a screen prompting selection of a feeding cassette storing a sheet compatible with the second mode among a plurality of feeding cassettes each storing a sheet of a different type may be displayed.

### Control Flow of Square Back Process

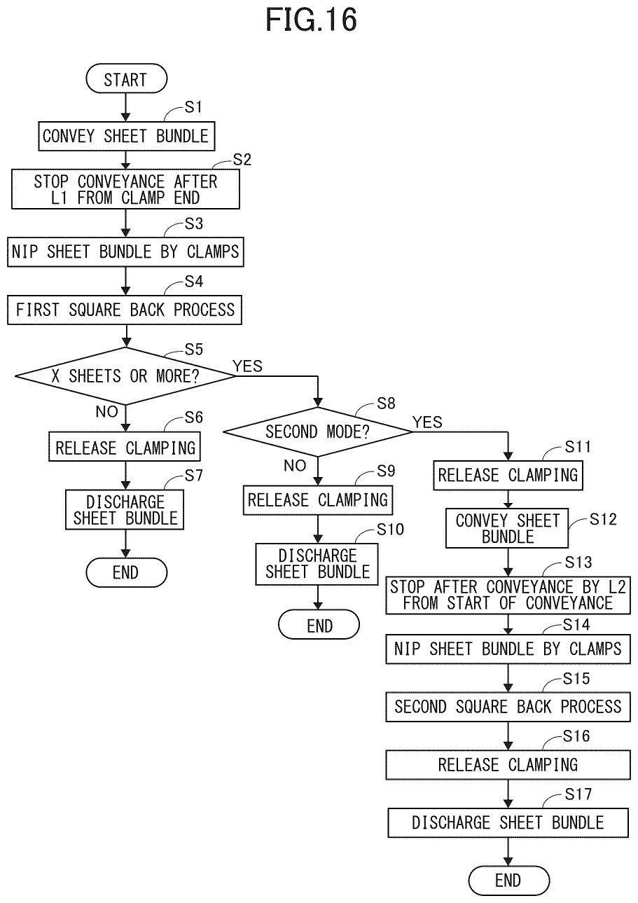

Next, an example of a control flow of the square back process described above will be described with reference to FIG. 16. Here, the second mode in which the square back process is performed twice is particularly effective for a sheet bundle including a predetermined number or more (for example, 20 or more) of sheets. In the case where the number of sheets in the sheet bundle is less than the predetermined number, corners can be sufficiently formed on the spine of the sheet bundle without executing the second mode. In addition, in the case where the second mode is executed when the number of sheets in the sheet bundle is less than the predetermined number, there is a possibility that a product of a low quality is formed as a result of, for example, the corners formed on the spine of the sheet bundle being crushed too much. Therefore, in the flow described below, the second mode is executable in the case where the number of sheets in the sheet bundle is equal to or more than the predetermined number (equal to or more than X), and in the case where the number of sheets in the sheet bundle is less than the predetermined number, similarly to the case described with reference to FIGS. 14 and 15 described above, the second mode is cancelled and the first mode is executed even if the second mode is selected. To be noted, the control described below is executed by the saddle controller 350 of the sheet processing apparatus B in accordance with a command from the controller 310 of the image forming apparatus A. The saddle controller 350 obtains information about the sheet such as the number of sheets included in the sheet bundle and the grammage of the sheet in each cassette from the image forming apparatus A via the communication portion 341.

First, when the control is started, sheets are conveyed to the saddle portion B2 as described above, and the sheet bundle subjected to the saddle binding process and the half-folding process is conveyed to the square back processing unit C2 by the saddle third roller pair 118 (S1). Next, the conveyance of the sheet bundle is stopped at a position where the spine of the sheet bundle protrudes by L1 from the end surface (hereinafter, clamp end) on the downstream side in the conveyance direction of each of the upper clamp unit 121 and the lower clamp unit 120 (S2). The sheet bundle is clamped by the upper clamp unit 121 and the lower clamp unit 120 in this state (S3). The protrusion amount of the spine of the sheet bundle from the clamp end in this state is P1 (see FIG. 11B). Then, the first square back process is executed on the sheet bundle in a state in which the sheet bundle is clamped (S4).

The saddle controller 350 determines whether or not the number of sheets in the sheet bundle is equal to or more than X (S5), and in the case where the number of sheets is less than X (NO in S5), the nipping of the sheet bundle by the upper clamp unit 121 and the lower clamp unit 120 is released to execute the first mode even if the second mode is selected (S6). Then, the sheet bundle subjected to the square back process is discharged (S7).

In the case where the number of sheets in the sheet bundle is equal to or more than X in S5 (YES in S5), the saddle controller 350 checks whether or not the second mode is selected (S8). In the case where the second mode is not selected (NO in S8), the nipping of the sheet bundle by the upper clamp unit 121 and the lower clamp unit 120 is released (S9), and the sheet bundle subjected to the square back process is discharged (S10).

In the case where the second mode is selected in S8 (YES in S8), the nipping of the sheet bundle by the upper clamp unit 121 and the lower clamp unit 120 is released to execute the second mode (S11). Next, the sheet bundle is conveyed by the saddle third roller pair 118 (S12), and the conveyance of the sheet bundle is stopped at a position where the spine of the sheet bundle protrudes by L2 (L2≤L1) from the clamp end (S13). In this state, the sheet bundle is clamped by the upper clamp unit 121 and the lower clamp unit 120 (S14). The protrusion amount of the spine of the sheet bundle from the clamp end in this state is P2 (see FIG. 12B). Then, the second square back process is performed on the sheet bundle in a state in which the sheet bundle is clamped (S15). After the execution, the nipping of the sheet bundle by the upper clamp unit 121 and the lower clamp unit 120 is released (S16), and the sheet bundle subjected to the square back process is discharged (S17).

To be noted, S5 described above may be the type of the sheet described with reference to FIGS. 14 and 15 instead of the number of sheets in the sheet bundle. For example, S5 may be changed to “Is the grammage of the sheet more than a predetermined value Y (80 g/m²)”. In addition, the second mode may be made executable in the case where the number of sheets and the type of the sheet in the sheet bundle are both satisfied in S5.

To be noted, regarding whether or not the second mode is to be executed, execution may occur not only in accordance with the selection of the mode as described above but also in the case where the sheet bundle set to be subjected to the square back process by the user is a thick bundle. That is, the second mode may be executed in accordance with the number of sheets in the sheet bundle and the grammage set by the user. To be noted, in a case like this, a protrusion amount at which the pressing roller 123 can damage the spine in the case of moving thereonto may be set as a predetermined protrusion amount, and the second mode may be executed in the case where the protrusion amount of the spine Ssp of the sheet bundle Sb from the end surfaces 121b and 120c of the upper clamp unit 121 and the lower clamp unit 120 determined in accordance with the thickness (bulkiness) of the sheet bundle exceeds the predetermined protrusion amount.

In addition, a configuration in which the protrusion amount of the spine (or the intensity of the square back process) at the time of the square back process can be set by the user and the second mode is executed in the case where the value set by the user exceeds the predetermined protrusion amount described above may be employed. In this case, in the case where the predetermined protrusion amount is such a protrusion amount that a damage occurs when the pressing roller 123 climbs over, the protrusion amount for the first time may be set to a protrusion amount that equal to or less than the predetermined protrusion amount and that does not cause a damage, and the protrusion amount for the second time may be determined such that the protrusion amount in total with the protrusion amount for the first time is the protrusion amount set by the user.

### Other Embodiments

Although the square back process is performed on the downstream side in the saddle portion B2 in the sheet processing apparatus B in the embodiment described above, a similar square back process may be performed in a different casing connected from the outside. For example, it may be a single unit that performs only the square back process without performing the saddle binding process or the half-folding process. In this case, this unit includes the square back processing unit C2 described above, and a conveyance unit such as a conveyance roller pair that conveys the sheet bundle subjected to the saddle binding process and the half-folding process to the square back processing unit C2.

In addition, although the sheet processing apparatus B includes a controller to control each element in the sheet processing apparatus B in the embodiment described above, a configuration in which each element in the sheet processing apparatus B is controlled by a controller included in the image forming apparatus may be employed.

Further, although a roller pair has been described as a conveyance unit that conveys the sheet in the sheet processing apparatus B in the embodiment described above, a configuration in which the sheet is conveyed by a belt may be employed. Specifically, any of a configuration in which the sheet is nipped and conveyed by a pair of belts, and a configuration in which the sheet is nipped by a belt and roller may be employed, and the configuration for conveyance may be changed in accordance with the position and path for the conveyance of the sheet. For example, a configuration in which the sheet is conveyed by a pair of rollers at one position and the sheet is conveyed by a pair of belts at another position may be employed.

In addition, although the image forming system 1000 in which the sheet processing apparatus B is directly connected to the image forming apparatus A has been described in the embodiment described above, a different system configuration may be employed. For example, a configuration in which a different processing apparatus, conveyance apparatus, or the like is connected between the image forming apparatus A and the sheet processing apparatus B may be employed. In addition, although the image forming apparatus A that forms a monochromatic image by using toner has been described as an example in the embodiment described above, an image forming apparatus that forms a color image by using toner or an image forming apparatus that forms an image on a sheet by using an ink may be employed.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, damage to the spine of the sheet bundle caused by the square back process on the sheet bundle can be suppressed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A sheet processing apparatus comprising:
a conveyance unit configured to convey a sheet bundle subjected to a saddle binding process and a half-folding process such that a spine of the sheet bundle is positioned downstream of a fore edge thereof in a conveyance direction;
a square back processing unit including a pair of clamping units configured to clamp and release a sheet bundle conveyed by the conveyance unit and a pressing roller, the square back processing unit being configured to perform a square back process in which the pair of clamping units clamp the sheet bundle such that the spine of the sheet bundle protrudes downstream from the pair of clamping units in the conveyance direction and the pressing roller presses the spine of the sheet bundle toward the pair of clamping units while moving along the spine of the sheet bundle clamped by the pair of clamping units; and
a controller capable of executing a mode in which, the square back processing unit perform the square back process to the sheet bundle conveyed by the conveyance unit, after the pair of clamping units release the clamping of the sheet bundle subjected to the square back process, the conveyance unit conveys the sheet bundle downstream in the conveyance direction, and the square back processing unit performs the square back process to the sheet bundle conveyed downstream by the conveyance unit again.

2. The sheet processing apparatus according to claim 1,
wherein the controller controls the square back processing unit and the conveyance unit such that a protrusion amount of the spine of the sheet bundle clamped by the pair of clamping units from the pair of clamping units in a state before pressing by the pressing roller is a first protrusion amount, and controls the square back processing unit and the conveyance unit such that the protrusion amount of the spine of the sheet bundle clamped by the pair of clamping units in the state before the pressing by the pressing roller from the pair of clamping units is a second protrusion amount equal to or less than the first protrusion amount when performing the square back process again on the sheet bundle subjected to the square back process.

3. The sheet processing apparatus according to claim 2, wherein the controller adjusts the protrusion amount by controlling a conveyance amount of the sheet bundle by the conveyance unit in the square back process.

4. The sheet processing apparatus according to claim 1, wherein the controller is capable of executing a first mode to execute the square back process only once on one sheet bundle, and a second mode to execute the square back process a plurality of times on one sheet bundle.

5. The sheet processing apparatus according to claim 4, wherein the controller executes the second mode in a case where a number of sheets included in the sheet bundle to be subjected to the square back process is equal to or larger than a predetermined number.

6. The sheet processing apparatus according to claim 4, wherein the controller executes the second mode in a case where a grammage of a sheet included in the sheet bundle to be subjected to the square back process exceeds a predetermined value.

7. An image forming system comprising:
an image forming unit configured to form an image on a sheet;
a saddle binding processing unit configured to perform a saddle binding process on a sheet bundle including the sheet on which the image has been formed by the image forming unit;
a half-folding processing unit configured to perform a half-folding process on the sheet bundle subjected to the saddle binding process by the saddle binding processing unit;
a conveyance unit configured to convey the sheet bundle subjected to the saddle binding process and the half-folding process such that a spine of the sheet bundle is positioned downstream of a fore edge thereof in a conveyance direction;
a square back processing unit including a pair of clamping units configured to clamp and release a sheet bundle conveyed by the conveyance unit and a pressing roller, the square back processing unit being configured to perform a square back process in which the pair of clamping units clamp the sheet bundle such that the spine of the sheet bundle protrudes downstream from the pair of clamping units in the conveyance direction and the pressing roller presses the spine of the sheet bundle toward the pair of clamping units while moving along the spine of the sheet bundle clamped by the pair of clamping units; and
a controller capable of executing a mode in which, the square back processing unit perform the square back process to the sheet bundle conveyed by the conveyance unit, after the pair of clamping units release the clamping of the sheet bundle subjected to the square back process, the conveyance unit conveys the sheet bundle downstream in the conveyance direction, and the square back processing unit performs the square back process to the sheet bundle conveyed downstream by the conveyance unit again.
